(19) United States
(12) Patent Application Publication
(10) Pub. No.: US 2018/0165380 A1
(43) Pub. Date: Jun. 14, 2018

(54) DATA PROCESSING SYSTEM AND DATA PROCESSING METHOD

(71) Applicant: HITACHI, LTD., Tokyo (JP)

(72) Inventors: Tsukasa SHIBAYAMA, Tokyo (JP); Hironori EMARU, Tokyo (JP); Kouichi MURAYAMA, Tokyo (JP)

(73) Assignee: HITACHI, LTD., Tokyo (JP)

(21) Appl. No.: 15/736,190

(22) PCT Filed: Mar. 29, 2016
(86) PCT No.: PCT/JP2016/060192

§ 371 Date: Dec. 13, 2017

(51) Int. Cl. G06F 17/30; G06F 3/06

(52) U.S. Cl. CPC G06F 17/30979; G06F 17/30991; G06F 3/0683; G06F 3/0665; G06F 3/0604

(57) ABSTRACT

First-type metadata of unstructured data is associated with second-type metadata including content information indicating one or more content attributes of the unstructured data. For each of one or more pieces of unstructured data, two or more pieces of first-type metadata include: a first piece which is original metadata of the unstructured data; and a second piece based on a copy of the first piece with which the second-type metadata appropriate to a retrieval condition is associated. A data processing system displays information relating to a plurality of virtual volumes recommended for parallel use. The plurality of virtual volumes are associated with two or more second pieces of first-type metadata based on one or a plurality of overlapping degrees of a plurality of pieces of first-type metadata with which a plurality of pieces of second-type metadata appropriate to at least one of a plurality of retrieval conditions are associated.

### TECHNICAL FIELD

This invention generally relates to data processing.

### BACKGROUND ART

Data managed by a storage system can be used for various uses such as retrieval, analysis, and the like.

For example, in big data analysis, analysis of unstructured data such as files of which the storage structure is not fixed is expected to be a useful method for obtaining new knowledge and awareness in business. In big data analysis, data retrieval takes a considerable amount of time since analysis is performed on a large amount of data. In order to prevent completion of analysis from taking a large amount of time, a set of data necessary for analysis only may be created from a large amount of data. The set of necessary data only is referred to as a “data mart” (hereinafter DM), creation of the data set is referred to as a “DM creation process”. PTL 1 discloses a technique of creating the data mart.

### CITATION LIST

### Patent Literature

### [PTL 1]

### Japanese Patent Application Publication No. 2002-366401

### SUMMARY OF INVENTION

### Technical Problem

Some users may want to create a large number (for example, several hundreds) of DMs and perform analysis in order to perform data analysis from a large number (for example, several hundreds) of view points.

However, when several hundreds of DMs are created using the technique of PTL 1, the time and capacity required for copying increases enormously.

On the other hand, when analysis is performed without creating a DM, since retrieval is performed on a large amount of data, the data retrieval takes a considerable amount of time. Moreover, access may concentrate on a specific storage device (for example, a storage device based on a data source called a DWH (data warehouse) or a DL (data lake)) and a bottleneck may occur.

Such a problem is not limited to a process of creating a DM from an unstructured data source for the purpose of analysis but may also occur in a process of creating a data set (a subset) from the unstructured data source for purposes other than analysis.

### Solution to Problem

With first-type metadata of at least one piece of unstructured data among a plurality of pieces of unstructured data included in an unstructured data source, second-type metadata which is metadata including content information indicating one or more content attributes of the unstructured data is associated. For each of one or more pieces of unstructured data, two or more pieces of first-type metadata that refer to the unstructured data include a first piece of first-type metadata and a second piece of first-type metadata. The first piece of first-type metadata is original metadata of the unstructured data. The second piece of first-type metadata is metadata based on a copy of the first piece of first-type metadata associated with the second-type metadata suitable for a retrieval condition. A data processing system displays recommendation information which is information related to a plurality of virtual volumes recommended to be used in parallel. With the plurality of virtual volumes, two or more second pieces of first-type metadata based on one or a plurality of overlapping degrees of a plurality of pieces of first-type metadata associated with a plurality of pieces of second-type metadata suitable for at least one of a plurality of retrieval conditions is associated. Each of the one or plurality of overlapping degrees is a value corresponding to a data amount of an overlapping portion of at least two reference destinations corresponding to at least two pieces of first-type metadata.

### Advantageous Effects of Invention

The retrieval condition is a retrieval condition corresponding to an analysis view point, for example. A data set suitable for such a retrieval condition can be generated without retrieving unstructured data in the unstructured data source and copying the unstructured data. Due to this, it is possible to generate a data set suitable for the retrieval condition in a short time while suppressing an increase in a consumed storage capacity. Furthermore, it is possible to display information on a plurality of virtual volumes recommended to be used in parallel. As a result, it is possible to reduce the time necessary for processes for generating a data set and performing processes using the data set.

### BRIEF DESCRIPTION OF DRAWINGS

FIG. 1 illustrates an overview of Embodiment 1.

FIG. 2 illustrates an overview of an example of a series of processes including a C-snap process and processes previous and subsequent thereto.

FIG. 3 is a block diagram of a computer system according to Embodiment 1.

FIG. 4 illustrates an example of a snapshot process.

FIG. 5 illustrates a configuration of a storage management table.

FIG. 6 illustrates a configuration of S-meta management information and S-meta attribute information included in one piece of S-meta.

FIG. 7 illustrates a configuration of C-meta management information included in one piece of C-meta.

FIG. 8 illustrates a configuration of a copy pair management table.

FIG. 9 illustrates a configuration of a configuration management table.

FIG. 10 is a flowchart of a data read process.

FIG. 11 is a flowchart of a data write process.

FIG. 12 is a flowchart of an extraction process.

FIG. 13 is a flowchart of C-snap (sorting).

FIG. 14 is a flowchart of C-snap (snap acquisition).

FIG. 15 is a flowchart of an overlap checking process.

FIG. 16 is a block diagram of a computer system according to Embodiment 2.

FIG. 17 illustrates a configuration of a performance management table.

FIG. 18 is a flowchart of an entire process from an extraction process to an overlap checking process.

FIG. 19 is a flowchart of S5920.

FIG. 20 is a flowchart of S5960.

FIG. 21 illustrates an overview of a scale-out process.

### DESCRIPTION OF EMBODIMENTS

Hereinafter, several embodiments will be described with reference to the drawings.

In the following description, an “interface unit” includes one or more interfaces. One or more interfaces may be one or more interface devices of the same type (for example, one or more NICs (Network Interface Cards)) and may be two or more interface devices of different types (for example, an NIC and an HBA (Host Bus Adapter)).

In the following description, a “storage unit” includes one or more memories. At least one memory may be a volatile memory or may be a nonvolatile memory. The storage unit may include one or more PDEVs in addition to one or more memories. The “PDEV” means a physical storage device and typically may be a nonvolatile storage device (for example, an auxiliary storage device). The PDEV may be an HDD (Hard Disk Drive) or an SSD (Solid State Drive), for example.

Moreover, in the following description, a “processor unit” includes one or more processors. At least one processor is typically a CPU (Central Processing Unit). A processor may include a hardware circuit that performs a part or all of processes.

Moreover, in the following description, although a process is described using a “program” as a subject, since a program is executed by a processor unit to perform a predetermined process while using at least one of a storage unit and an interface unit appropriately, the subject of the process may be the processor unit (or a computer or a computer system having the processor unit). The program may be installed from a program source to a computer. The program source may be a program distribution computer or a computer-readable recording medium. Moreover, in the following description, two or more programs may be implemented as one program, and one program may implement two or more programs.

Moreover, in the following description, although information is sometimes described using an expression of an “xxx table,” the information may be expressed by an arbitrary data structure. That is, the “xxx table” may be referred to as “xxx information” in order to show that information does not depend on a data structure. Moreover, in the following description, the configuration of each table is an example, one table may be divided into two or more tables, and all or a portion of two or more tables may be integrated into one table.

Moreover, in the following description, when the same types of elements are not distinguished from each other, reference symbols (or common portions in the reference symbols) may be used, whereas when the same types of elements are distinguished from each other, IDs of the elements (or the reference symbols of the elements) may be used.

Moreover, in the following description, a “host system” may be one or more physical host computers (for example, a cluster of host computers) and may include at least one virtual host computers (for example, VMs (Virtual Machines)).

Moreover, in the following description, a “management system” may include one or more computers. Specifically, for example, when a management computer has a display device and the management computer displays information on a display device thereof, the management computer may be a management system. Moreover, for example, when a management computer (for example, a server) transmits display information to a remote display computer (for example, a client) and the display computer displays the information (when a management computer displays information on a display computer), a system including at least one of the management computer and the display computer may be a management system.

Moreover, in the following description, a “storage system” may be one or more physical storage apparatuses and may include at least one virtual storage apparatuses (for example, LPARs (Logical Partitions) or SDSs (Software Defined Storages)).

Moreover, in the following description, “RAID” stands for Redundant Array of Independent (or Inexpensive) Disks. A RAID group is made up of a plurality of PDEVs (typically PDEVs of the same type) and stores data according to a RAID level associated with the RAID group. A RAID group may be referred to as a parity group. A parity group may be a RAID group that stores a parity, for example.

In the following description, “VOL” stands for a logical volume and may be a logical storage device. A VOL may be a real VOL (RVOL) or a virtual VOL (VVOL). A “RVOL” may be a VOL based on a physical storage resource (for example, one or more RAID groups) included in a storage system that provides the RVOL. A “VVOL” may be any one of an externally storage VOL (EVOL), a capacity expanded VOL (TPVOL), and a snapshot VOL. An EVOL is based on a storage space (for example, a VOL) of an external storage system and may be a VOL based on a storage virtualization technology. A TPVOL is made up of a plurality of virtual areas (virtual storage areas) and may be a VOL based on a capacity virtualization technology (typically Thin Provisioning). A snapshot VOL may be a VOL provided as a snapshot of an original VOL. A snapshot VOL may be an RVOL. A “pool” may be a logical storage area (for example, a set of a plurality of pool VOLs). For example, pools may include at least one of a TP pool and a snapshot pool. A TP pool may be a storage area made up of a plurality of real areas (real storage areas). When a real area is not allocated to a virtual area (a virtual area of a TPVOL) to which an address designated by a write request received from a host system belongs, a storage system (for example, a storage controller to be described later) may allocate a real area from a TP pool to the virtual area (a write destination virtual area) (that is, even when another real area is allocated to the write destination virtual area, a new real area may be allocated to the write destination virtual area). A storage system may write the write target data associated with the write request to the allocated real area. A snapshot pool may be a storage area in which data saved from an original VOL is stored. One pool may be used as a TP pool and a snapshot pool. A “pool VOL” may be a VOL that serves as a component of a pool. A pool VOL may be an RVOL or an EVOL.

### Embodiment 1

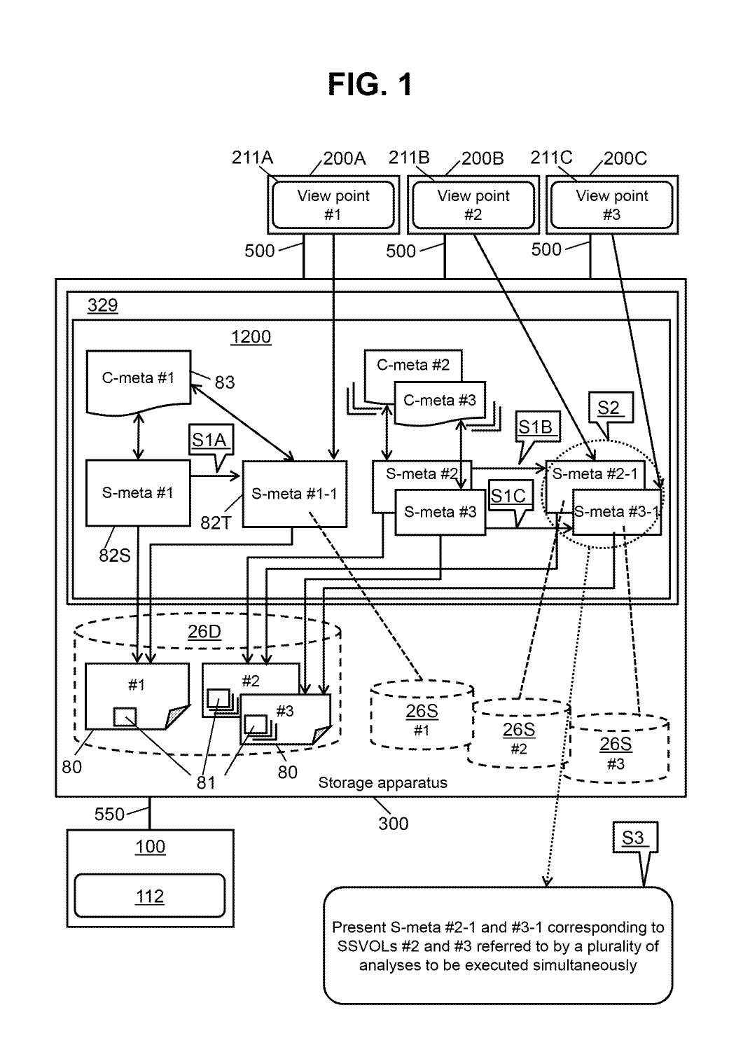

FIG. 1 illustrates an overview of Embodiment 1.

A computer system according to Embodiment 1 includes one or more host computers 200, a management computer 100, and a storage apparatus 300. The host computer 200 is coupled to the storage apparatus 300 via a network 500. The management computer 100 is coupled to the storage apparatus 300 via a network 550.

The host computer 200 executes an application program (hereinafter an application) 211. For example, a host computer 200A executes an analysis application 211A. The management computer 100 executes a management program 112.

The storage apparatus 300 is an object storage apparatus and has a storage controller 329. The storage controller 329 has a local memory 1200 and provides a VOL 26. The VOL 26 includes at least a data VOL 26D. The data VOL 26D is an example of a data source (typically an unstructured data source) such as a name space or a DWH (Data Ware House). A data chunk 81 is stored in the data VOL 26D. In the present embodiment, a “data chunk” is a meaningful unit of data (for example, a still image, a moving image, an email). The data chunk may be a portion (for example, data of a certain period) among time-series data including data from sensors, for example. One or more data chunks 81 having a common predetermined data attribute are included in the same object. In the present embodiment, an “object” is a dataset including one or more data chunks 81 and one piece of S-meta 82 corresponding to the one or more data chunks 81. For example, when the data chunk 81 is data from a data issuing source (for example, a sensor such as a camera), respective pieces of data from the same data issuing source are a “data chunk”, and a plurality of data chunks from the same data issuing source (a plurality of data chunks having a common data attribute of “issuing source”) are included in the same “object”. The “unstructured data” may be a concept that includes so-called semi-structured data. Hereinafter, one or more data chunks included in one object will be referred to as a “data chunk unit”. The “unstructured data” may be respective data chunks in an object, a partial data chunk, or a data chunk unit.

In the present embodiment, two types of metadata are present. At least a portion of the two types of metadata is stored in the local memory 1200. In the present embodiment, the two types of metadata are referred to as “S-meta” and “C-meta”. An S-meta 82 (or S-meta attribute information 1220 to be described later corresponding to one data chunk) is an example of a first-type metadata and a C-meta 83 is an example of a second-type metadata. In the present embodiment, the S-meta 82 and the object are in one-to-one correspondence. Therefore, the S-meta 82 and the data chunk 81 are in one-to-one or one-to-many correspondence. On the other hand, the C-meta 83 and the data chunk 81 are in one-to-one or many-to-one correspondence, because there are extraction program to be described later for each user and, in this case, the pieces of C-meta 83 created by the same data chunks 81 may be different depending on the extraction program. Therefore, the S-meta 82 and the C-meta 83 are in one-to-one or one-to-many correspondence. The S-meta 82 is metadata associated with the data chunk unit 80 (all data chunks 81) included in an object, and for example, includes an S-meta ID (an object ID) and information indicating a storage location of each data chunk 81 included in the corresponding object. On the other hand, the C-meta 83 is metadata including content information indicating one or more content attributes specified from the data chunk 81 (a data content) extracted from the data VOL 26D. The “content attribute” is an attribute of the content of data, and for example, is a data type (for example, an image or an email) and a time point (for example, an acquisition time point or an update time point). The content information is information expressed as a text (for example, a character string) and may include other types of information (for example, a number indicating a characteristic amount or the like) instead of or in addition to the text. The S-meta 82 and the C-meta 83 also contain information for indicating the mutual relation. Specifically, the C-meta 83 refers to the S-meta 82 that refers to the data chunk 81 corresponding to the C-meta 83, and the S-meta 82 referred to by the C-meta 83 refers to the C-meta 83. That is, the C-meta 83 and the S-meta 82 corresponding to the same data chunk 81 refer to each other. Instead of such bidirectional reference (link), unidirectional reference from the C-meta 83 to the S-meta 82 may be employed. Since the C-meta 83 is one type of metadata of the data chunk 81, the C-meta 83 has a smaller data amount than the data chunk 81. Moreover, the S-meta 82 and the object is not limited to one-to-one correspondence (for example, many-to-many or one-to-many correspondence).

The host computer 200 issues an I/O (Input/Output) request to the storage apparatus 300. The I/O request is a write request or a read request. When the I/O request is a read request, an object ID corresponding to a read target data chunk 81 is designated. Upon receiving a read request from the host computer 200A, for example, the storage controller 329 specifies the S-meta 82 in which the object ID designated by the read request is described, reads the data chunk 81 indicated by the specified S-meta 82 from the data VOL 26D, and sends the data chunk 81 to the host computer 200A as a response.

The storage controller 329 executes a DM creation process. The DM creation process starts in response to a user request which is a specific type of request from a user. The user request may be an explicit request for DM creation and may be a request defined as one of DM creation requests such as a retrieval request. In the present embodiment, the storage controller 329 receives a retrieval request from the user (for example, an analyzer) of the host computer 200 and receives a DM creation request from the user (for example, an administrator) of the management computer 100. In the user request, a retrieval condition (a condition of data to be included in a DM) corresponding to an analysis view point or the like. For example, at least one of a data type (for example, a picture and an email), a data issuing source (for example, a sensor model number), a position (for example, a data acquisition position such as a capturing position), a time period (for example, a time period such as a capturing time point), and a data value range (for example, an upper limit and a lower limit of a metric value included in data) can be used as the retrieval condition.

Generally, an address of an area (for example, a VOL area) in which the data chunk 81 is actually stored is not designated as the retrieval condition. This is because users do not generally know such an address.

However, the DM creation process according to the present embodiment is expected to end in a short time from at least one (Reason 3) of the following reasons (Reasons 1 to 3).

(Reason 1) In the DM creation process, the C-meta 83 is referred to and the data chunk 81 in the data VOL 26D is not referred to.

(Reason 2) The C-meta 83 referred to in the DM creation process is the C-meta 83 (for example, the C-meta 83 created before the DM creation process starts) created asynchronously to the DM creation process. In other words, the C-meta 83 is created by a trigger different from the user request which is a trigger of the start of a DM creation process. For example, when the data chunk 81 is stored in the data VOL 26D, the C-meta 83 of the data chunk 81 is created.

(Reason 3) It is not necessary to copy the data chunk 81 in order to create a DM. That is, the created DM is not a real DM in which a copy of the data chunk 81 in the data VOL 26D is stored but is a virtual DM (hereinafter a VDM) that refers to the data chunk 81 in the data VOL 26D. In the present embodiment, a VDM is an SSVOL (snapshot VOL) 26S. In order to create the SSVOL 26S, a first S-meta 82S may be copied and it is not necessary to copy the data chunk 81 itself. Since it cannot be said that the data chunk 81 included in a VDM is all reference destination data chunks 81 of the S-meta 82, a second S-meta 82T which is metadata based on a copy of the first S-meta 82S may not be completely identical to the first S-meta 82S. The first S-meta 82S is original metadata included in an object, and the second S-meta 82T is metadata based on a copy of the first S-meta 82S as described above. The first S-meta 82S is an example of a first piece of first-type metadata and the second S-meta 82T is an example of a second piece of second-type metadata. That is, in the present embodiment, the S-meta 82 includes the first S-meta 82S and the second S-meta 82T. The second S-meta 82T is data containing information on a snapshot data chunk (an entity is a data chunk in the data VOL 26D) which is a data chunk that can be referred to via the SSVOL 26S. Therefore, it is not always necessary to use a convenient data name like metadata. For example, the second S-meta 82T may be referred to as another name like snapshot management data (in this case, the first S-meta may be referred to simply as “S-meta” or “metadata” as no confusion arises).

From the above-described reasons, hereinafter, DM creation according to the present embodiment is referred to as “C-snap” and a DM creation process is referred to as a “C-snap process”. The DM is an example of a data set and the VDM is an example of a virtual data set.

According to the example of FIG. 1, for example, asynchronously to a retrieval request from the analysis application 211A (the host computer 200A) (for example, before a C-snap process starts in response to a retrieval request), the storage controller 329 creates pieces of C-meta #1, #2, and #3 corresponding to data chunk units #1, #2, and #3 in the data VOL 26D and stores the created pieces of C-meta in the local memory 1200. The C-meta #1 refers to the first S-meta #1 that refers to the data chunk unit #1, the C-meta #2 refers to the first S-meta #2 that refers to the data chunk unit #2, and the C-meta #3 refers to the first S-meta #3 that refers to the data chunk unit #3. According to the example of FIG. 1, the data chunk unit #1 is one data chunk, and therefore, one piece of C-meta #1 is associated with the first S-meta #1 that refers to the data chunk unit #1. On the other hand, the data chunk units #2 and #3 each are a plurality of data chunks, and therefore, a plurality of pieces of C-meta including the C-meta #2 are associated with the first S-meta #2 that refers to the data chunk unit #2, and a plurality of pieces of C-meta including the C-meta #3 are associated with the first S-meta #3 that refers to the data chunk unit #3.

According to the example of FIG. 1, the storage controller 329 starts a C-snap process in response to a retrieval request. The C-snap process is broadly classified into two processes of “C-snap (sorting)” and “C-snap (snap acquisition)”. In the C-snap (sorting), the storage controller 329 searches for the C-meta 83 suitable for a retrieval condition (for example, a condition corresponding to analysis view point #1) designated by the retrieval request from the present pieces of C-meta #1 to #3. That is, a retrieval range is not the data chunk 81 but the C-meta 83. When at least one piece of C-meta 83 suitable for the retrieval condition is found, the C-snap (snap acquisition) is executed. It is assumed that the C-meta #1 is found. In the C-snap (snap acquisition), the storage controller 329 creates a second S-meta #1-1 based on a copy of the first S-meta #1 referred to by the C-meta #1 (S1A). The storage controller 329 creates an SSVOL #1 (VDM) to which the second S-meta #1-1 belongs. The storage controller 392 provides the SSVOL #1 to at least the host computer 200A (a retrieval request sender) among one or more host computers 200. The analysis application 211A (the host computer 200A) can execute analysis using one or more data chunks 81 referred to by the second S-meta #1-1 that belongs to the SSVOL #1. For example, any one of “R/W Enabled” (both read and write are enabled), “RO” (Read-Only (only read is enabled)), and “R/W Disabled” (read and write are disabled) may be employed as an access state (access restriction) of one or more data chunks 81 referred to by the SSVOL #1. For example, at least one of the following states may be employed.

(V1) When a providing destination of the SSVOL #1 is a plurality of host computers 200, an access state of the SSVOL #1 may be set to “RO”. In this way, it is possible to maintain consistency of data between the plurality of host computers 200.

(V2) When the providing destination of the SSVOL #1 is the host computer 200A only, the access state of the SSVOL #1 may be set to “R/W”. In this way, the host computer 200A can customize the SSVOL #1. For example, upon receiving a write request that designates the SSVOL #1, the storage controller 329 may store a data chunk associated with the write request in a pool.

As described above, since the C-snap process does not require a copy of the data chunk 81, it can be expected that the C-snap process ends in a short time. The C-meta 83 for the data chunk 81 referred to by the second S-meta 82T, which is associated with the first S-meta 82S which is a copy source of the second S-meta 82T is associated with the second S-meta 82T.

According to the example of FIG. 1, a portion of the data chunk unit #2 and a portion of the data chunk unit #3 overlap each other (are common portions). In other words, a partial data chunk 81 belongs to both an object that includes the data chunk unit #2 and an object that includes the data chunk unit #3. A portion of the second S-meta #2-1 and a portion of the second S-meta #3-1 overlap each other. Specifically, a portion of a reference destination of the second S-meta #2-1 and a portion of a reference destination of the second S-meta #3-1 are the same data chunk 81.

It is assumed that the analysis application 211B of the host computer 200B sent a retrieval request that designates a retrieval condition corresponding to the analysis viewpoint #2 to the storage controller 329. In this case, the storage controller 329 searches for the C-meta #2 suitable for the retrieval condition, copies the first S-meta #2 referred to by the C-meta #2 (S1B), creates the SSVOL #2 (VDM) to which the second S-meta #2-1 based on a copy of the first S-meta #2 belongs, and provides the SSVOL #2 to at least the host computer 200B (a retrieval request sender) among one or more host computers 200. Similarly, it is assumed that the analysis application 211C of the host computer 200C sent a retrieval request that designates the retrieval condition corresponding to the analysis view point #3 to the storage controller 329. In this case, the storage controller 329 searches for the C-meta #3 suitable for the retrieval condition, copies the first S-meta #3 referred to by the C-meta #3 (S1C), creates the SSVOL #3 (VDM) to which the second S-meta #3-1 based on a copy of the first S-meta #3 belongs, and provides the SSVOL #3 to at least the host computer 200C (a retrieval request sender) among one or more host computers 200.

A user request like a retrieval request may be issued by the management computer 100 instead of or in addition to the host computer 200. Moreover, a plurality of division view points (for example, a plurality of retrieval conditions corresponding to a plurality of division view points) may be designated by one user request. The storage controller 329 can specify designation of a plurality of division view points from one or more user requests.

In the present embodiment, it is possible to create the VDM (the SSVOL 26S) without performing retrieval of the data chunk 81 and copying of the data chunk 81. That is, it is possible to generate a DM suitable for the analysis view point in a short time while suppressing an increase in a consumed storage capacity. Due to this, a number (for example, several hundreds) of VDMs of different analysis viewpoints may be created. It is preferable that as many analyses as possible among a plurality of analyses corresponding to a plurality of analysis view points are executed in parallel. However, when a plurality of analyses are to be executed in parallel using a plurality of VDMs, a resource amount (for example, the capacity of a cache memory in which a reference target data chunk in the VDM is temporarily stored) is not always sufficient.

Therefore, in the present embodiment, a process which focuses on the above characteristics that some of reference destinations of the plurality of pieces of second S-meta 82T corresponding to a plurality of VDMs may overlap each other. That is, the storage controller 329 constructs (“construct” may include “update”) a group to which two or more pieces of second S-meta 82T corresponding to two or more VDMs (SSVOLs 26S) recommended to be used in parallel (for example, simultaneously) on the basis of an overlapping degree of a plurality of pieces of second S-meta 82T. Hereinafter, this group is referred to as an “analysis group”. The second S-meta 82T in the analysis group is known, the VDM corresponding to the second S-meta 82T and the C-meta 83 associated with the second S-meta 82T are known, and the analysis view point corresponding to the C-meta 83 is known. The storage controller 329 executes an analysis control process which is control based on one or more constructed analysis groups. The “plurality of pieces of second S-meta 82T” may be all pieces of second S-meta 82T managed by the storage controller 329 and may be the second S-meta 82T associated with one or more pieces of C-meta 83. The “one or more pieces of C-meta 83” is the C-meta 83 suitable for a plurality of analysis view points designated by one or more user requests.

The storage controller 329 may execute construction of the analysis group (for example, periodically) regardless of whether one or more user requests designating a plurality of analysis view points are received or not. For example, the storage controller 329 calculates an overlapping degree of a plurality of pieces of existing second S-meta 82T. The storage controller 329 constructs the analysis group on the basis of the overlapping degree of a plurality of pieces of existing second S-meta 82T and the existing C-meta 83 associated with the plurality of pieces of second S-meta 82T. After that, the storage controller 329 presents recommendation information which is information on the constructed analysis group when a request (for example, a recommendation display request) is received. The recommendation information may include at least one of information indicating all analyses (a plurality of analyses (analysis view points) recommended to be executed in parallel), information indicating all pieces of second S-meta 82T belonging to the analysis group, information (for example, a root ID to be described later) indicating the SSVOL 26S associated with the second S-meta 82T belonging to the analysis group, and information indicating the C-meta 83 associated with the second S-meta 82T belonging to the analysis group.

Alternatively, the storage controller 329 may execute construction of an analysis group and an analysis control process in response to one or more user requests upon receiving the one or more user requests that designate a plurality of analysis view points. For example, the storage controller 329 searches for the C-meta 83 suitable for each of a plurality of analysis view points and specifies the second S-meta 82T associated with the C-meta 83. The storage controller 329 calculates an overlapping degree of a plurality of pieces of second S-meta 82T specified for the plurality of analysis view points. The storage controller 329 constructs one or more analysis groups on the basis of the calculated overlapping degree. The storage controller 329 executes an analysis control process for the constructed one or more analysis groups. The analysis control process includes presenting the recommendation information for the constructed one or more analysis groups. Although at least one analysis group includes two or more pieces of second S-meta 82T, only one piece of second S-meta 82T may be included in any one of the analysis groups.

### <Overlapping Degree of a Plurality of Pieces of Second S-Meta 82T>

The “overlapping degree” of a plurality of pieces of second S-meta 82T is a value corresponding to a data amount of an overlapping portion of at least two reference destinations of the plurality of pieces of second S-meta 82T. Specifically, the “overlapping degree” of the plurality of pieces of second S-meta 82T, for example, may be the amount of a reference destination overlapping address range (in other words, an overlapping data chunk group) of the plurality of pieces of second S-meta 82T and may be the percentage of the amount of a reference destination overlapping address range (in other words, an overlapping data chunk group) to the amount of a reference destination address range (in other words, a data chunk group of a reference destination) of the plurality of pieces of second S-meta 82T. The “overlapping data chunk group” is one or more overlapping data chunks. The “overlapping data chunk” is a data chunk referred to from two or more pieces of second S-meta 82T among the plurality of pieces of second S-meta 82T.

As a first example, the overlapping degree of the plurality of pieces of second S-meta 82T may be an overlapping degree of a certain piece of second S-meta 82T and each of the remaining pieces of second S-meta 82T. When two or more pieces of second S-meta 82T included in one analysis group are nodes, the two or more pieces of second S-meta 82T have a star structure.

As a second example, the overlapping degree of the plurality of pieces of second S-meta 82T may be a value (for example, the sum or the mean) based on a plurality of overlapping degrees corresponding to a plurality of overlapping portions of the plurality of pieces of second S-meta 82T. Each of the plurality of overlapping portions is an overlapping portion of arbitrary two or more pieces of second S-meta 82T. When two or more pieces of second S-meta 82T included in one analysis group are nodes, the two or more pieces of second S-meta 82T have a tree structure.

### <Analysis Control Process>

The analysis control process is a process including at least one of the following processes (p) to (s).

(p) Process of presenting (displaying) recommendation information for constructed one or more analysis groups. The recommendation information includes for each of the constructed one or more analysis groups, at least one of information indicating all analyses (that is, analyses (analysis view points) recommended to be executed in parallel) specified from the analysis group, information (for example, an S-meta ID 1210001 to be described later) indicating all pieces of second S-meta 82T included in the analysis group, information (for example, a root ID to be described later) indicating the SSVOL 26S to which the second S-meta 82T included in the analysis group belongs, and information (for example, a C-meta ID 123001 and a user extension 123006 to be described later) indicating the C-meta 83 associated with the second S-meta 82T included in the analysis group. A presentation destination of the recommendation information may be at least one (for example, a sender of the user request serving as a trigger for presentation of the recommendation information) of the host computer 200 and the management computer 100.

(q) Process of selecting an analysis group suitable for a predetermined group condition from the constructed one or more analysis groups and copying the second S-meta 82T included in the selected analysis group, the data chunk 81 referred to by the second S-meta 82T, and the C-meta 83 associated with the second S-meta 82T to another storage apparatus. The “predetermined group condition” means referring to a data chunk group having a larger capacity than the capacity of a cache memory, for example. An analysis group that refers to a data chunk group (at least an overlapping data chunk group) having a larger capacity than the capacity of a cache memory will be referred to as a “large-capacity analysis group”. On the other hand, an analysis group that refers to a data chunk group (at least an overlapping data chunk group) having a capacity equal to or smaller than the capacity of a cache memory will be referred to as a “small-capacity analysis group”.

(r) Process of thinning out a large-capacity analysis group from the constructed one or more analysis groups. The process (p) may be performed on analysis groups remaining as the result of the process (r). That is, the presented analysis group may be the small-capacity analysis group only. The small-capacity analysis group only may be constructed when the analysis group is constructed. For example, when an analysis group is constructed, a small-capacity analysis group including one or more pieces of second S-meta 82T that refer to a data chunk group having a capacity equal to or smaller than the capacity (the cache memory capacity specified from a configuration management table 1240 to be described later) of the cache memory may be constructed.

(s) Process of employing a low-overlapping-degree analysis group instead of an analysis group which is a high-overlapping-degree analysis group and a large-capacity analysis group. The “low-overlapping-degree analysis group” is an analysis group including two or more pieces of second S-meta 82T of which the overlapping degree is smaller than a threshold. On the other hand, the “high-overlapping-degree analysis group” is an analysis group which includes two or more pieces of second S-meta 82T of which the overlapping degree is equal to or larger than a threshold and does not include two or more pieces of second S-meta 82T of which the overlapping degree is smaller than the threshold. The process (p) may be executed after the process (s) is performed. The process (s) has the following advantages, for example. That is, when a plurality of analyses belonging to an analysis group which is a high-overlapping-degree analysis group and a large-capacity analysis group are executed in parallel, overlapping data chunks which can be referred to highly frequently overflow from a cache memory. Therefore, accesses may concentrate on the same PDEV 1500. On the other hand, when the process (s) is executed, it is possible to reduce the possibility of accesses concentrating on the same PDEV 1500. This is because there are a small number of overlapping data chunks and an access destination can be distributed to a plurality of PDEVs 1500.

According to the example of FIG. 1, the storage controller 329 receives designations of a plurality of division view points #2 and #3, finds pieces of C-meta #2 and #3 corresponding to the plurality of division view points #2 and #3, and calculates the overlapping degree of a plurality of pieces of second S-meta #2-1 and #3-1 associated with the pieces of C-meta #2 and #3. The storage controller 329 selects pieces of second S-meta #2-1 and #3-1 corresponding to the calculated overlapping degree (S2), creates an analysis group including the selected pieces of second S-meta #2-1 and #3-1 and presents the pieces of second S-meta #2-1 and #3-1 as S-meta corresponding to the SSVOLs #2 and #3 recommended to be used in parallel (S3). The pieces of second S-meta #2-1 and #3-1 may be an example of two or more pieces of second S-meta 82T of which the overlapping degree is equal to or larger than the threshold. A large overlapping degree means that there are many data chunks 81 having a high reference frequency, and there being many data chunks 81 having a high reference frequency means a high possibility that the data chunk 81 referred to during analysis is present in a cache memory of the storage controller 329. Therefore, it can be expected that the time required for a plurality of analyses is shortened.

Hereinafter, the present embodiment will be described in detail.

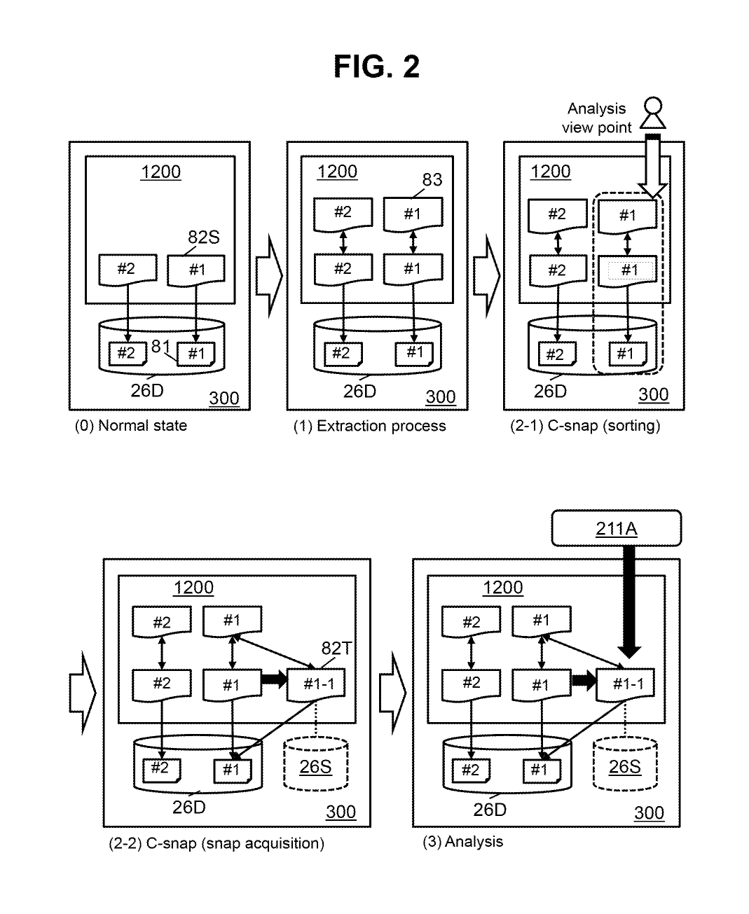

FIG. 2 illustrates an overview of an example of a series of processes including a C-snap process and processes previous and subsequent thereto.

According to the example of FIG. 2, States before a C-snap process is performed are “(0) Normal state” and “(1) Extraction process”. The “(0) Normal state” is a state before the C-meta 83 is created. In the “(1) Extraction process”, the C-meta 83 is created. The C-meta 83 refers to the first S-meta 82S.

The C-snap process is broadly classified into two processes of “(2-1) C-snap (sorting)” and “(2-2) C-snap (snap acquisition)”.

“(3) Analysis” is performed after the C-snap process is performed as described above.

The details of FIG. 2 will be described later.

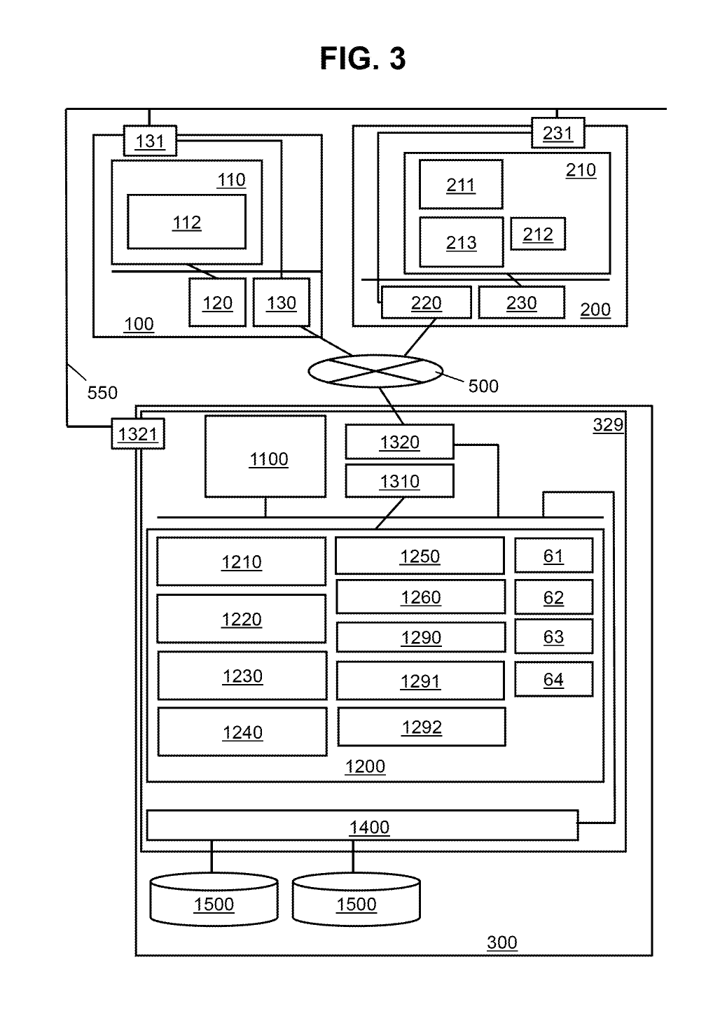

FIG. 3 is a block diagram of a computer system according to Embodiment 1.

As described above, the computer system includes the management computer 100, the host computer 200, and the storage apparatus 300. As for the management computer 100, host computers 200, and storage apparatus 300, at one or more of these may be provided. The management computer 100 is an example of a management system. The host computer 200 is an example of a host system. The storage apparatus 300 is an example of a storage system.

The management computer 100, the host computer 200, and the storage apparatus 300 are coupled to each other via the network (for example, a LAN (Local Area Network)) 500. Moreover, the management computer 100, the host computer 200, and the storage apparatus 300 are coupled via a network (for example, a SAN (Storage Area Network)) 550. The networks 500 and 550 may be integrated with each other.

The management computer 100 includes an I/F (interface) 131, an I/F 130, a memory 110, and a processor 120 coupled to these components. The I/Fs 131 and 130 are examples of an interface unit. The I/F 131 is coupled to the network 550. The I/F 130 is coupled to the network 500. The memory 110 stores a management program 112. The processor 120 can issue a request to the storage apparatus 300 by executing the management program 112. The request may be a write request, a read request, a copy control request, or the like.

The host computer 200 includes an I/F 231, an I/F 230, a memory 210, and a processor 220 coupled to these components. The I/F 231 and I/F 230 are examples of an interface unit. The I/F 231 is coupled to the network 550. The I/F 230 is coupled to the network 500. The memory 210 stores programs such as an OS (Operating System) 212, an application 211, and an agent program 213. The processor 220 executes a program in the memory 210. For example, the processor 220 sends an I/O request to the storage apparatus 300 by executing a program. In this way, it is possible to access the VOL 26 provided by the storage apparatus 300.

The application 211 is an analysis application, for example. For example, the analysis application performs an analysis process such as correlation analysis. The OS 212 controls an entire process of the host computer 200. The agent program 213 can send an instruction to the management computer 100 and the management computer 100 can forward the instruction to the storage apparatus 300. When it is desired to use a storage function, the analysis application 211 can perform storage control in a manner of being synchronized with an analysis process with the aid of the management program 112 using the agent program 213. For example, when the analysis application has a DM creation function, in response to a DM creation operation by a user, the agent program 213 sends the content of the operation to the management program 112, and the management program 112 converts the operation content to a copy control request and sends the copy control request to the storage apparatus 300.

The storage apparatus 300 includes one or more PDEVs 1500 and a storage controller 329 coupled thereto.

One or more PDEVs 1500 may form one or more RAID groups. The PDEV 1500 is an HDD or an SSD, for example. The data chunk 81 and the like stored in the data VOL 26D are stored in one or more PDEVs 1500. At least a portion of the plurality of pieces of C-meta 83 and the plurality of pieces of S-meta 82 may be stored in one or more PDEVs 1500.

The storage controller 329 includes an I/F 1321, an I/F 1320, an I/F 1400, a cache memory 1100, a local memory 1200, and a processor 1310 coupled thereto. The local memory 1200 stores information and programs. The processor 1310 refers to or updates information in the local memory 1200, performs I/O with respect to a VOL, creates the C-meta 83, and executes a C-snap by executing the program in the local memory 1200.

The I/F 1321, I/F 1320, and I/F 1400 are examples of an interface unit. The I/F 1321 is coupled to the network 550. The I/F 1320 is coupled to the network 500. The I/F 1400 is coupled to one or more PDEVs 1500.

The cache memory 1100 and the local memory 1200 are examples of a storage unit. The cache memory 1100 and the local memory 1200 may be one memory, and a cache area as a cache memory and a local memory area as a local memory may be provided in the memory.

The cache memory 1100 is a memory for temporarily storing data (for example, data (write target data or read target data) corresponding to an I/O request from the host computer 200) input and output to and from one or more PDEVs 1500.

The local memory 1200 stores information and programs. Specifically, for example, the local memory 1200 stores S-meta management information 1210, S-meta attribute information 1220, C-meta management information 1230, a configuration management table 1240, a storage management table 1250, and a copy pair management table 1260. Moreover, for example, the local memory 1200 stores an I/O program 61, an object program 62, a data processing program 63, a snapshot program 64, an extraction program 1290, a C-snap program 1291, and an overlap checking program 1292.

The S-meta management information 1210 and the S-meta attribute information 1220 are present for each piece of S-meta 82. The S-meta management information 1210 is information for managing objects. The S-meta attribute information 1220 is information for managing data chunks 81.

The C-meta management information 1230 is present for each piece of C-meta 83. The C-meta 83 includes content information indicating one or more content attributes specified from the data chunk 81. The C-meta management information 1230 is at least a portion of the C-meta 83.

The storage management table 1250 is a table that stores information on the VOL 26 provided by the storage apparatus 300. The copy pair management table 1260 is a table that stores information on a copy configuration to which the SSVOL 26S belongs.

The I/O program 61 is a program for processing I/O requests. The object program 62 is a program for processing objects. The data processing program 63 is a program that accesses the VOL 26. The snapshot program 64 is a program that creates the SSVOL 26S.

The extraction program 1290 is a program that extracts the data chunk 81 and creates the C-meta 83 on the basis of the extracted data chunk 81. The C-snap program 1291 is a program that executes a C-snap process. The overlap checking program 1292 checks the overlapping degree of a plurality of pieces of S-meta 82. At least one of the extraction program 1290, the C-snap program 1291, and the overlap checking program 1292 may be a user program which is a program created by a user. That is, at least one of the extraction program 1290, the C-snap program 1291, and the overlap checking program 1292 may be present for each user, and at least one of the extraction program 1290 and the C-snap program 1291 corresponding to the user of the host computer 200 may be executed. Since at least one of the extraction program 1290, the C-snap program 1291, and the overlap checking program 1292 is a user program, at least one of the C-meta 83 and the SSVOL 26S (VDM) with which a desirable analysis result is obtained by a user (for example, an analyzer) can be expected.

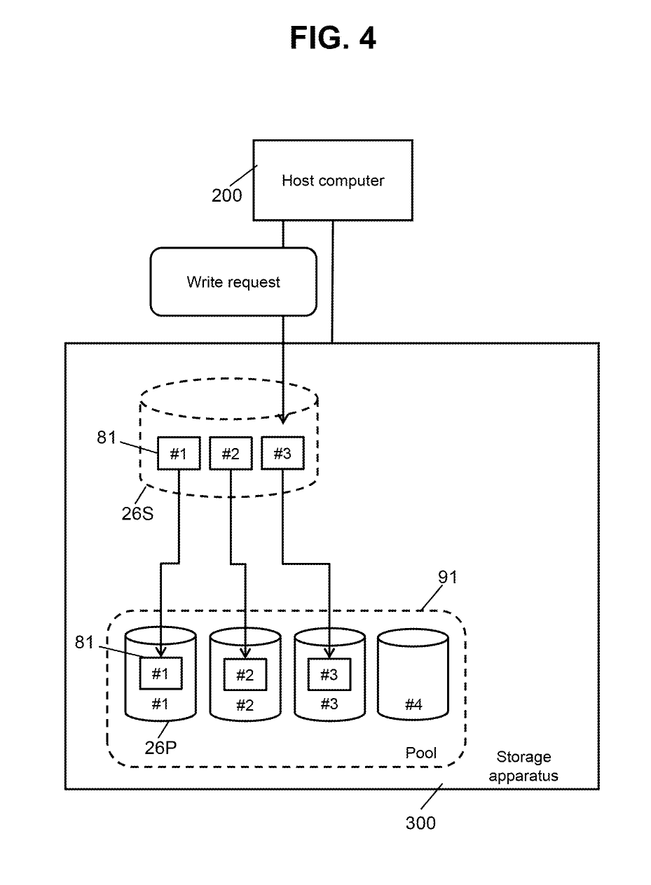

FIG. 4 illustrates an example of a snapshot process.

The snapshot process is a process performed when writing data to the SSVOL 26S. The storage controller 329 manages a pool 91 made up of one or more pool VOLs 26P (pool VOLs #1 to #4).

The storage controller 329 receives a write request that designates the SSVOL 26S from the host computer 200. The write request is a write request that designates an object ID of an object including a reference destination data chunk of S-meta (an S-meta copy) belonging to the SSVOL 26, for example. The storage controller 329 stores the data chunk 81 (for example, #1) corresponding to the write request in the pool 91 rather than the reference destination of the SSVOL 26 (S-meta). That is, the write target data chunk 81 is stored in the pool VOL 26P which is an example of a VOL different from a reference destination VOL of the SSVOL 26 (S-meta). The storage controller 329 manages association between a virtual address (the address of the area of the SSVOL 26S) of the data chunk and a real address (the address of the area of the pool VOL 26P) of the data chunk 81. In this manner, a Redirect-on-write-type process may be employed as the snapshot process. That is, when a write occurs for a data chunk in the SSVOL 26S (or the data VOL 26D), the write is performed on a new area, and areas (addresses) indicated by the first S-meta 82S and the second S-meta 82T are rewritten. Although the Redirect-on-write-type snapshot process may be employed in this manner, a snapshot process of other types such as a Copy-on-write type may be employed.

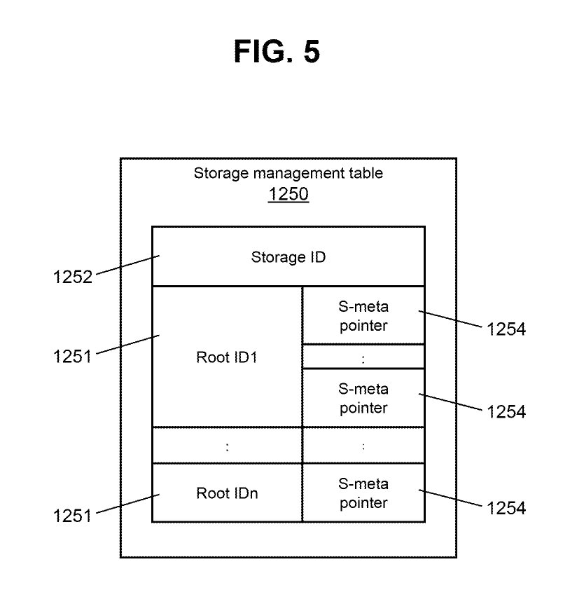

FIG. 5 illustrates a configuration of the storage management table 1250.

The storage management table 1250 includes a storage ID 1252. Each storage ID 1252 includes one or more root IDs 1251.

The storage ID 1252 is information indicating an identifier (a storage ID) of the storage apparatus 300.

The root ID 1251 is information indicating an identifier (a root ID) of a root. The root ID 1251 of a root of the storage apparatus 300 is associated with the storage ID 1252 of the storage apparatus 300. In the present embodiment, the “root” is a group of one or more pieces of S-meta 82. The VOL 26 is present for each root. Due to this, for example, the root ID can be said to be an identifier (VOL ID) of the VOL. An S-meta pointer 1254 of the S-meta 82 belonging to a root is associated with the root ID 1251 of the root. The S-meta pointer 1254 is information (a pointer) indicating the location of the S-meta 82 in the local memory 1200.

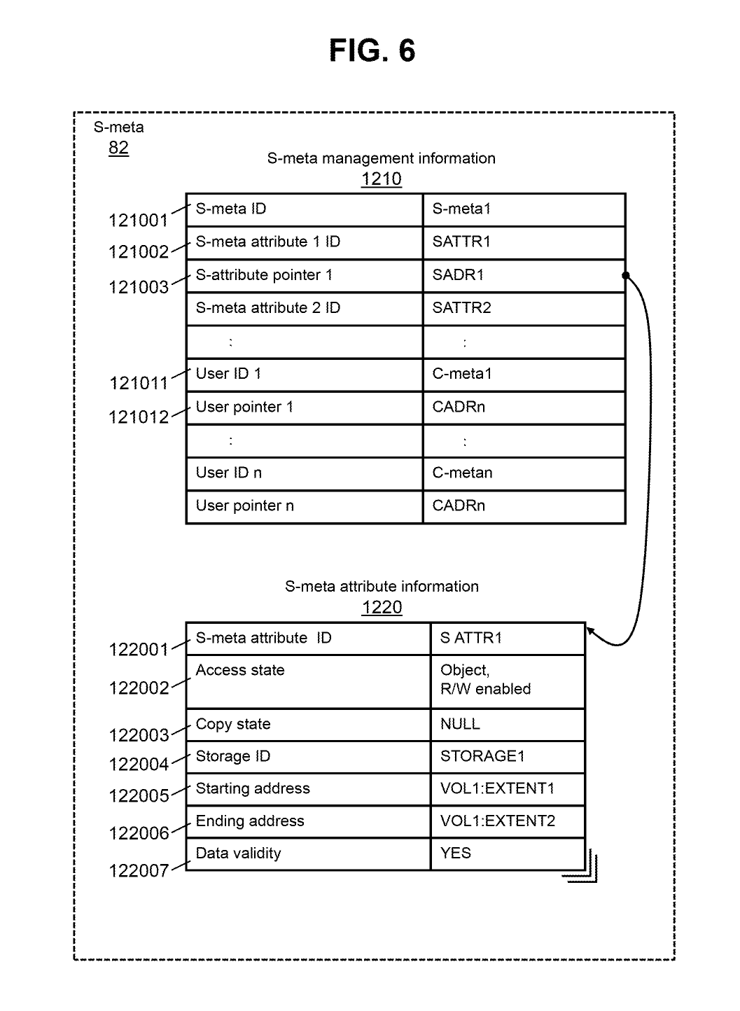

FIG. 6 illustrates a configuration of the S-meta management information 1210 and the S-meta attribute information 1220 included in one piece of S-meta 82.

The S-meta 82 is made up of the S-meta management information 1210 and the S-meta attribute information 1220. As described above, the S-meta management information 1210 manages objects and the S-meta attribute information 1220 manages the data chunks 81. The S-meta attribute information 1220 is associated with the S-meta management information 1210 with respect to the respective data chunks 81 in the object corresponding to the S-meta management information 1210.

The S-meta management information 1210 includes an S-meta ID 121001. The S-meta ID 121001 is information indicating an identifier (an S-meta ID) of S-meta. In other words, the S-meta ID is an object ID.

Moreover, the S-meta management information 1210 includes an S-meta attribute ID 121002 and an S-attribute pointer 12103 for each data chunk 81 in the corresponding object. The S-meta attribute ID 121002 is information indicating an identifier (an S-meta attribute ID) of the S-meta attribute information 1220. The S-attribute pointer 121003 is information (a pointer) indicating the location of the local memory 1200 of the S-meta attribute information 1220. In this way, it is possible to specify the C-meta 83 as the reference destination of the S-meta 82.

Moreover, the S-meta management information 1210 includes a user ID 12011 and a user pointer 121012 for each piece of C-meta 83 that refers to the S-meta 82 including the S-meta management information 1210. The user ID 121011 is information indicating an identifier (a C-meta ID) of the C-meta 83, and specifically, is information used when managing additional information (that is, the C-meta 83) assigned to the S-meta management information 1210 by the user program (for example, the extraction program 1290) and is an identifier of additional information. The user pointer 121012 is information (a pointer) indicating the location of the local memory 1200 of the C-meta management information 1230 in which the C-meta 83 is included.

The S-meta attribute information 1220 includes an S-meta attribute ID 122001, an access state 122002, a copy state 122003, a storage ID 122004, a starting address 122005, an ending address 122006, and a data validity 122007.

The S-meta attribute ID 122001 is information indicating an S-meta attribute ID. The S-meta attribute ID may be an identifier (a data chunk ID) of a data chunk. Anyone of the object ID and the data chunk ID may be designated in an I/O request.

The access state 122002 is information indicating an access method and an access restriction to the data chunk 81. Examples of the access method include an object access (“Object”) which is an object-based access, a block access which is a block-based access, and a file access which is a file-based access. Examples of the access restriction include “R/W Enabled”, “RO”, and “R/W Disabled”. The access state 122002 may further include information on a user who is allowed to access.

The copy state 122003 is information indicating a copy state for a data chunk. For example, examples of the copy state 122003 include “SVOL” (indicating a data chunk referred to from the SSVOL 26S), “NULL” (indicating that the data chunk 81 is not a copy target), and the like.

The storage ID 122004 is information indicating an identifier (a storage ID) of a storage apparatus in which the data chunk 81 is stored. Like another embodiment to be described later, there is a case in which the data chunk 81 referred to by the S-meta 82 is disposed in a storage apparatus 300 different from the storage apparatus 300 in which the S-meta 82 is present. The processor 1310 can specify the storage apparatus 300 that stores the corresponding data chunk 81 by referring to the storage ID 122004.

The starting address 122005 is information indicating a starting address of an area in which the data chunk 81 is present. The ending address 122006 is information indicating an ending address of an area in which the data chunk 81 is present. The data validity 122007 is information (for example, a flag) indicating whether the data chunk 81 itself is valid. “YES” means valid and “NO” means invalid. For example, when there is S-meta #X that refers to data chunks #A and #B in the data VOL 26D, and S-meta #X′ (a copy of the S-meta #X) refers to the data chunk #A only among the data chunks #A and #B, the data validity 12007 corresponding to the data chunk #A for the S-meta #X′ is “YES” whereas the data validity 12007 corresponding to the data chunk #B is “NO”.

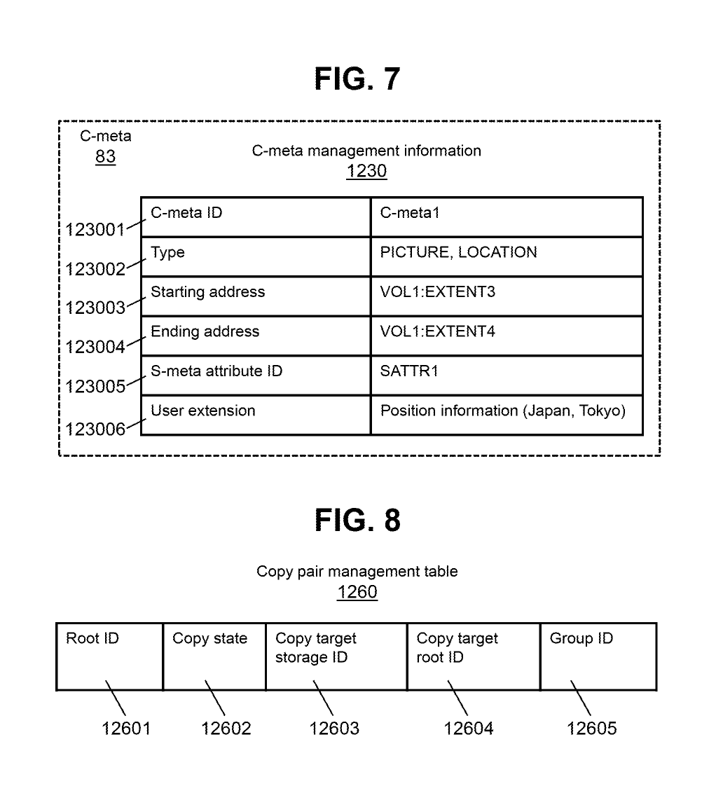

FIG. 7 illustrates a configuration of the C-meta management information 1230 included in one piece of C-meta 83.

The C-meta management information 1230 is at least a portion of the C-meta 83. The C-meta management information 1230 includes a C-meta ID 123001, a type 123002, a starting address 123003, an ending address 123004, an S-meta attribute ID 123005, and a user extension 123006.

The C-meta ID 123001 is information indicating an identifier (a C-meta ID) of the C-meta 83. The S-meta 82 (the S-meta 82 including the same C-meta ID as the user ID 121011) of a reference destination of the C-meta 83 is known from the C-meta ID 123001.

The type 123002 is information indicating the type of the C-meta 83. The type 123002 is referred to when the C-snap program 1291 performs retrieval using a metadata type as a view point.

The starting address 123003 is information indicating a starting address of an area (for example, the area of the VOL 26) in which information (for example, a portion of the content information (a portion of the C-meta 83)) associated with the C-meta management information 1230 is stored. The ending address 123004 is information indicating an ending address of an area in which information associated with the C-meta management information 1230 is stored. When the entire C-meta 83 is present in the local memory 1200, the starting address 123003 and the ending address 123004 are “NULL”.

The S-meta attribute ID 123005 is information indicating an S-meta attribute ID of the S-meta attribute information 1220 indicating the data chunk corresponding to the C-meta 83. The S-meta attribute information 1220 indicating the data chunk 81 corresponding to the C-meta 83 can be specified from the S-meta attribute ID 123005.

The user extension 123006 is extension information appended by the user program and is at least a portion of the content information. For example, when the extracted data chunk 81 is a captured image, information on a capturing position of the image is included in the C-meta management information 1230 as the user extension 123006.

FIG. 8 illustrates a configuration of the copy pair management table 1260.

The copy pair management table 1260 is a table that stores information on a configuration of a copy pair. The copy pair management table 1260 stores a root ID 12601, a copy state 12602, a copy target storage ID 12603, a copy target root ID 12604, and a group ID 12605.

The root ID 12601 is information indicating an identifier (a root ID) of a root. The copy state 12602 is information indicating a present state of a copy for a root (for example, a VOL) identified from the root ID 12601. The copy target root ID 12604 is information indicating an identifier of a copy target root which is a root that forms a pair with a root indicated by the root ID 12601. The copy target root may be either a copy source or a copy destination. At least one of the root ID 12601 and the copy target root ID 12604 may include information (for example, a symbol) on whether the root corresponding to the information indicates anyone of the copy source and the copy destination. The group ID 12605 is information indicating an identifier (a group ID) of a copy group including the copy pair.

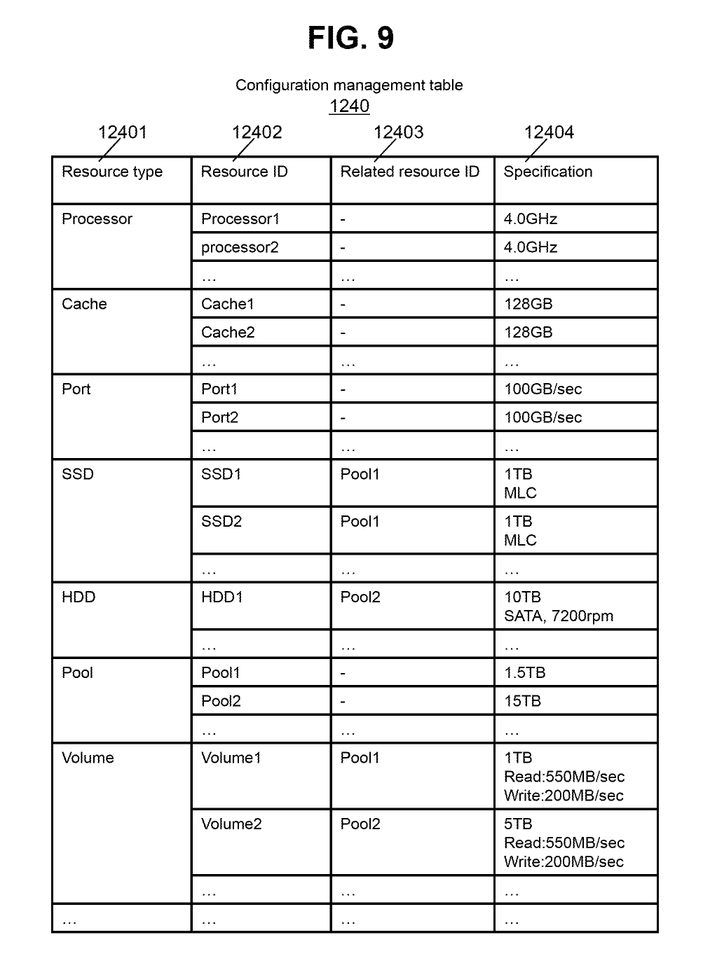

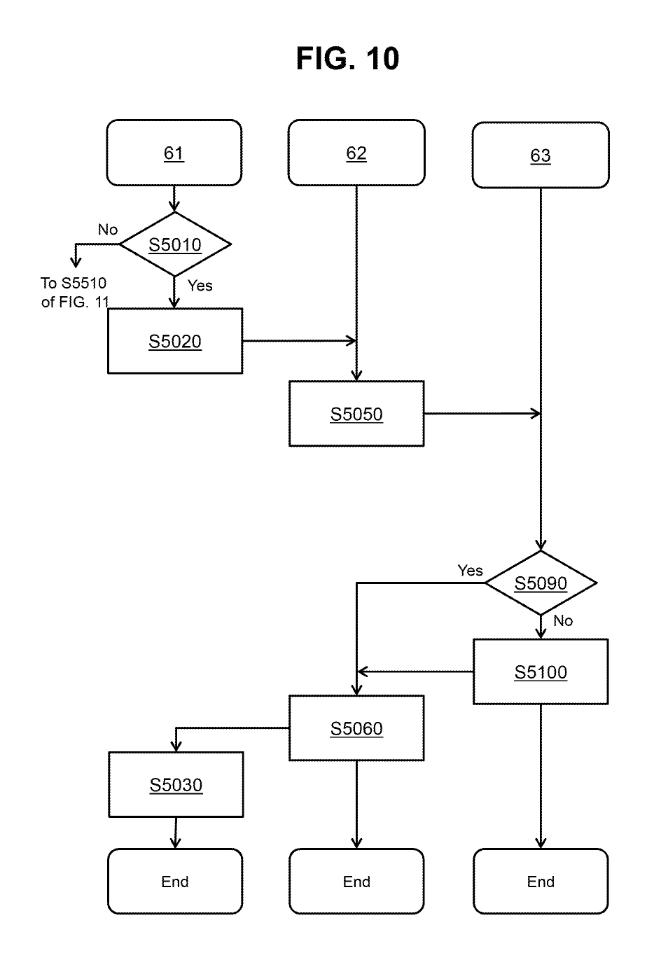

FIG. 9 illustrates a configuration of the configuration management table 1240.

The configuration management table 1240 is a table that stores information on a configuration of the storage apparatus 300. The configuration management table 1240 has a record for each resource (component) of the storage apparatus 300. Each record stores information such as a resource type 12401, a resource ID 12402, a related resource ID 12403, and a specification 12404.

The resource type 12401 is information indicating the type of a resource. Examples of the value of the resource type 12401 include a “Processor”, “Cache” (the cache memory 1100), “Port” (for example, the port of the I/F 1320 that receives an I/O request from the host computer 200), “SSD” (an example of the PDEV 1500), “HDD” (an example of the PDEV 1500), “Pool” “for example, the pool 91 in FIG. 4”, and “Volume” (the abovementioned VOL).

The resource ID 12402 indicates an identifier of a resource. The related resource ID 12403 indicates an identifier of a resource related to the resource, specifically, an identifier of a parent resource of the resource. The “parent resource” means a one level higher resource among resources related to the resource. The “upper-layer resource” means a resource on the upper layer (on the side close to the host computer 200) than the resource. In the storage apparatus 300, a plurality of resources form a tree structure as a plurality of resource nodes. In the tree structure, the side close to the host computer 200 is an upper layer and the side close to the PDEV 1500 is the lower layer.

The specification 12404 indicates a specification of the resource. When the resource type 12401 is “Processor”, the value of the specification 12404 is frequency. When the resource type 12401 is “Cache”, the value of the specification 12404 is a capacity. In this manner, the value (unit) of the specification 12404 may be a value corresponding to the resource type.

The information stored in the configuration management table 1240 may be stored in the format illustrated in FIG. 5 instead of the format illustrated in FIG. 9.

Hereinafter, several processes performed by Embodiment 1 will be described.

FIG. 10 is a flowchart of a data read process.

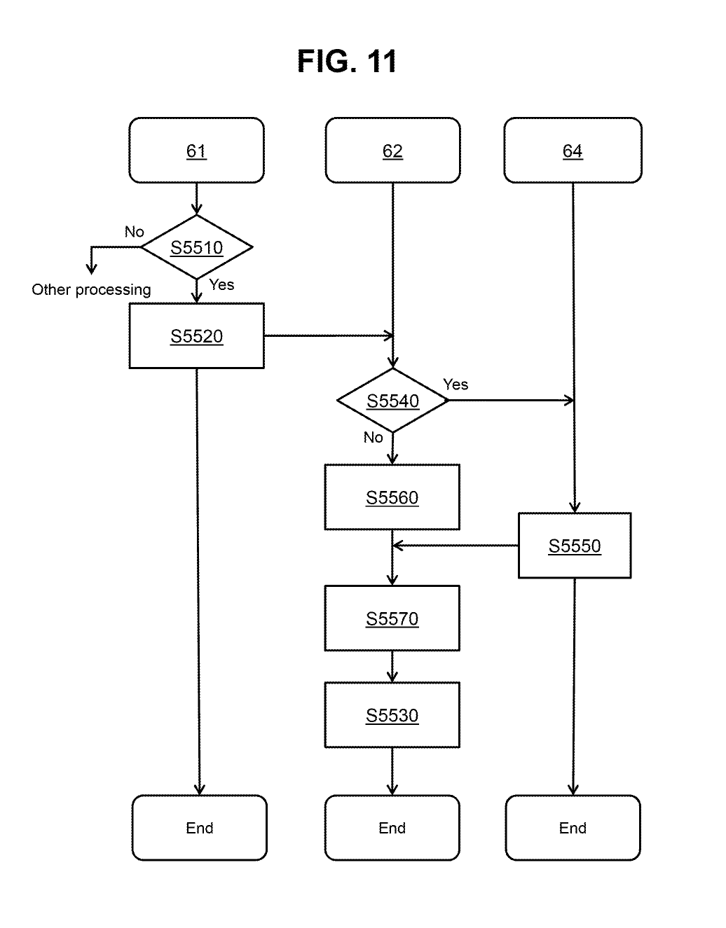

When the storage apparatus 300 receives an I/O request from the host computer 200, the I/O program 61 determines whether the I/O request is a read request (S5010). When the determination result in S5010 is false (S5010: No), the flow proceeds to S5510 in FIG. 11.

When the determination result in S5010 is true (S5010: Yes), the I/O program 61 converts the read request to a common read request and passes the converted read request to the object program 62 (S5020). The reason why an I/O request such as a read request is converted to a common I/O request is to enable various protocols (access methods) to be used as the protocol of the I/O request. For example, protocols called blocks, files, and objects are known, and by converting any of the protocols to a common I/O request, the processes after conversion can be performed in common. For example, an object access protocol is an input/output protocol which performs data access using objects as a basic unit, and an operation format can be operated using a Web interface such as a REST (Representational State Transfer) protocol. Specifically, the operation format can be operated by the following format, for example.

### PUT <OBJECT ID> <WRITE|READ|COPY CONTROL> [<OPTION>]

With S5020, the I/O request can be converted to a common request of the following common format.

### WRITE|READ|COPY <OBJECT ID> [<OPTION>]

Subsequently, S5050 is performed. That is, the object program 62 converts a read source address corresponding to the common read request to the address of a VOL. In this conversion, the S-meta management information 1210 and the S-meta attribute information 1220 are used. Specifically, the object program 62 refers to the S-meta management information 1210 including the S-meta ID 121001 identical to the object ID in the common request and refers to the S-meta attribute information 1220 from the S-attribute pointer 121003 of the S-meta management information 1210. Subsequently, the object program 62 acquires the starting address 122005 and the ending address 122006 included in the S-meta attribute information 1220. The object program 62 converts the object ID in the common request to the starting address and the ending address indicated by the acquired addresses 122004 and 122005 and passes the common request after conversion to the data processing program 63.

The data processing program 63 determines whether the data specified from the common request is present in the cache memory 1100 (S5090). When the determination result in S5090 is false (S5090: No), the data processing program 63 writes the data in the cache memory 1100 and passes the process to the object program 62 (S5100).

When the determination result in S5090 is true (S5090: Yes), or after S5100 is performed, the object program 62 reads the data from the cache memory 1100 (S5060). The I/O program 61 returns the data to the host computer 200 which is the sender of the read request (S5030).

As described above, in the data access process in the storage apparatus 300, since three programs 61 to 63 operate in parallel and cooperate as necessary, it is possible to read the data corresponding to the read request from the VOL 26 and return the same to the host computer 200. The read source VOL may be the data VOL 26D or the SSVOL 26S. In the data read process, it may be determined whether reading is allowed on the basis of the access state 122002 corresponding to the read target data chunk 81.

FIG. 11 is a flowchart of a data write process.

The I/O program 61 determines whether the I/O request is a write request (S5510). When the determination result in S5510 is false (S5510: No), a process corresponding to the request is performed.

When the determination result in S5510 is true (S5510: Yes), the I/O program 61 converts the write request to the common request of the storage apparatus 300 (S5520).

Subsequently, the object program 62 determines whether the copy state 122003 of the write target data (object) corresponding to the common request is “SVOL” (S5540). Specifically, the object program 62 specifies the S-meta management information 1210 of the same S-meta ID 121001 as the object ID in the common request, specifies the S-meta attribute information 1220 from the S-attribute pointer 121003 of the S-meta management information 1210, and refers to the copy state 122003 of the specified S-meta attribute information 1220.

When the copy state 122003 is “SVOL” (S5540: Yes), the snapshot program 64 changes the write destination VOL to another VOL (a pool VOL) (S5550). Specifically, the snapshot program 64 refers to the S-meta management information 1210 including the S-meta ID 121001 identical to the object ID in the common request and refers to the S-meta attribute information 1220 from the S-attribute pointer 121003 of the S-meta management information 1210. Subsequently, the snapshot program 64 acquires the starting address 122005 and the ending address 122006 of the S-meta attribute information 1220 and changes the VOL ID indicated by the addresses 122004 and 122005 to the ID of the pool VOL. In this way, it is possible to avoid the data chunk 81 referred to by the SSVOL 26S from being updated by the write to the SSVOL 26S.

When the copy state 122003 is not “SVOL” (S5540: No), S5560 is performed. That is, the object program 62 converts the object ID in the common request to the address of the VOL. Specifically, the object program 62 refers to the S-meta management information 1210 including the S-meta ID 121001 identical to the object ID and refers to the S-meta attribute information 1220 from the S-attribute pointer 121003 of the S-meta management information 1210. Subsequently, the object program 62 acquires the starting address 122005 and the ending address 122006 of the S-meta attribute information 1220 and replaces the object ID in the common request to the acquired addresses 122004 and 122005.

After S5550 or S5560 is performed, the object program 62 secures an area from the cache memory 1110 (S5570). Moreover, the object program 62 writes data corresponding to the common request to the secure area (S5530). When S5530 is completed, the I/O program 61 may return completion of write to the host computer 200 which is the sender of the write request. The data written to the cache memory 1110 is written to the PDEV 1500 corresponding to the area indicated by the write destination address of the data by the data processing program 63.

As described above, in the data access process of the storage apparatus 300, since three programs 61 to 63 operate in parallel and cooperate as necessary, it is possible to write the write target data to the cache memory 1100 and notify the host computer 200 of the completion of write. In the data write process, it may be determined whether writing is allowed on the basis of the access state 122002 corresponding to the write target data chunk 81.

Hereinafter, a series of processes including the C-snap process will be described with reference to FIG. 2 and FIGS. 12 to 14.

According to FIG. 2, “(0) Normal state” and “(1) Extraction process” are created and performed before a C-snap process is performed, the C-snap process includes “(2-1) C-snap (sorting)” and “(2-2) C-snap (snap acquisition)”, and “(3) Analysis” is performed after the C-snap process is performed.

### <(0) Normal State>

The data chunk 81 is stored in the storage apparatus 300, and the first S-meta 82S is associated with an object including the data chunk 81. The data chunk 81 may be image data generated from a monitoring camera and may be log information output by a manufacturing apparatus in a plant, for example.

According to FIG. 2, data chunks #1 and #2 are stored, and there are pieces of first S-meta #1 and #2 which refer to the data chunks #1 and #2.

### <(1) Extraction Process>

The extraction program 1290 operates on the processor 1310 at a time point at which at least one data chunk 81 is stored in the data VOL 26D of the storage apparatus 300, at a predetermined time interval, or at a time point at which a low processing load state of the processor 1310 is continued for a predetermined period time.

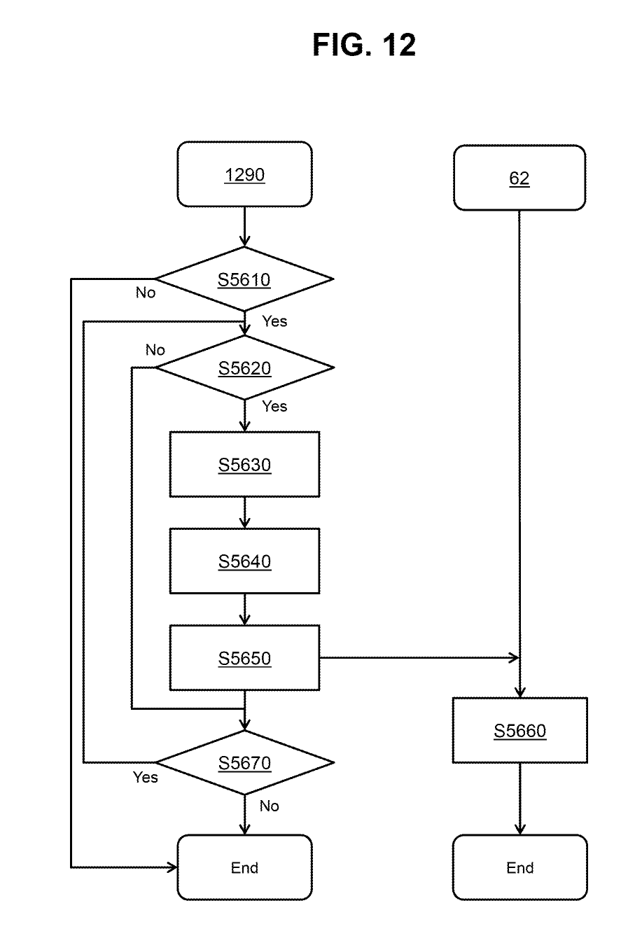

FIG. 12 is a flowchart of the extraction process.

The extraction process is performed by the extraction program 1290 and the object program 62. The target of the extraction process may be a root ID designated by the user. The root ID (for example, VOL ID) may be designated in advance. The extraction program 1290 is a program that acquires content information which can be an analysis view point from the data (objects) stored in the storage apparatus 300 and stores the C-meta 83 including the content information in the storage apparatus 300 in association with the S-meta 82 of the data. In the present embodiment, although the extraction program 1290 operates within the storage apparatus 300, the extraction program 1290 may operate in any one of the host computer 200 and the management computer 100.

The extraction program 1290 compares a time point at which the data chunk 81 is stored in a designated root (VOL) and the time point of a previous extraction process to determine whether a data chunk (hereinafter an updated data chunk) 81 of which the storage time point is earlier than the time point of the previous extraction process is present (S5610). When the determination result in S5610 is false (S5610: No), the process ends. The “time point of the previous extraction process” is a time point that is stored in the local memory 1200 by the extraction program 1290 in the previous extraction process.

When the determination result in S5610 is true (S5610: Yes), the extraction program 1290 extracts the updated data chunk 81 and determines whether the extracted updated data chunk 81 is a data chunk suitable for a predetermined extraction rule (S5620). For example, the extraction rule designates a data condition (a retrieval condition for extraction) of a data chunk to be extracted. The data condition may be a data type (for example, a picture and an email), for example. An extraction rule may be prepared for each user instead of or in addition to preparing the extraction program 1290 for each user.

When the determination result in S5620 is false (S5620: No), the flow proceeds to S5670 (the process may end).

When the determination result in S5620 is true (S5620: Yes), the extraction program 1290 extracts content information indicating one or more content attributes indicated by the updated data chunk 81 on the basis of the data type of the updated data chunk 81 from the updated data chunk 81 (S5630). When the content information is acquired from the updated data chunk 81, it is necessary to change an approach according to a data type. For example, when position information is acquired from an image, it is possible to acquire at least a portion of content information by referring to attribute information of an image file to read position information included in the attribute information.

Subsequently, the extraction program 1290 creates the C-meta 83 on the basis of the extracted content information (S5640). The content information may be stored in at least one of the local memory 1200 and the VOL 26. When the capacity of the content information is sufficiently smaller than the vacant capacity of the local memory 1200, the entire content information may be stored in the local memory 1200. The extraction program 1290 creates the C-meta management information 1230 based on the storage location of the content information. The C-meta ID 1230 is an arbitrary value. The starting address 123003 and the ending address 123004 may be “NULL” when the content information is stored in the local memory 1200. The S-meta attribute ID 123005 may be an identifier of the updated data chunk. The user extension 123006 may be at least a portion of the content information. As described above, since at least a portion of the content information is registered in the C-meta management information 1230, the entire content information is sometimes stored in the local memory 1200. On the other hand, at least a portion of the content information may be stored in the VOL 26. In this case, the address of the storage location of the content information can be obtained by asking the object program 62, for example. Moreover, when the entire content information is registered in the VOL, the user extension 123006 may be “NULL”.

Subsequently, the extraction program 1290 request the object program to register the C-meta 83 including the C-meta management information 1230 created in S5640 (S5650). In response to this request, the object program 62 associates the C-meta 83 with the first S-meta 82S that refers to the extracted updated data chunk 81 (S5660). Specifically, the object program 62 adds the same value as the C-meta ID 1230 to the S-meta management information 1210 in the S-meta 82 that refers to the extracted updated data chunk 81 as the user ID 121011 and adds a pointer to the C-meta management information 1230 as the user pointer 121012.

The extraction program 1290 performs the same determination as S5610 (S5670). When the determination result in S5670 is true (S5670: Yes), S5620 is performed on another updated data chunk. When the determination result in S5670 is false (S5670: No), the process ends.

According to FIG. 2, by the extraction process, the pieces of C-meta #1 and #2 corresponding to the data chunks #1 and #2 are created. The C-meta #1 refers to the first S-meta #1 and the C-meta #2 refers to the first S-meta #2. The pieces of C-meta #1 and #2 may include a designated retrieval condition (a data condition (for example, a time period)) and a retrieval result (for example, a search hit or miss) of the retrieval using the retrieval condition as a key instead of or in addition to the data type and the like as the content attribute.

### <(2-1) C-Snap (Sorting)>

A C-snap (sorting) is a process of sorting the C-meta 83 suitable for the retrieval condition from pieces of C-meta 83 associated with the first S-meta 82S. Although the C-snap program 1291 operates in the storage apparatus 300 in the present embodiment, the C-snap program 1291 may operate in either the management computer 100 or the host computer 200.

A user instructs the start of a C-snap process. The C-snap program 1291 receives this instruction. An instruction format is as follows, for example.

### CSNAP <SEARCH KEY> <TARGET ROOT ID> <COPY DESTINATION ROOT ID> <OPTION>

In the instruction format, the C-meta 83 corresponding to the data chunk 81 in the root designated by <TARGET ROOT ID> is narrowed down to the C-meta 83 suitable for the search key (retrieval condition) designated by <SEARCH KEY>. One or more pieces of first S-meta 82S referred to by the narrowed one or more pieces of C-meta 83 are copied under the root designated by <COPY DESTINATION ROOT ID>.

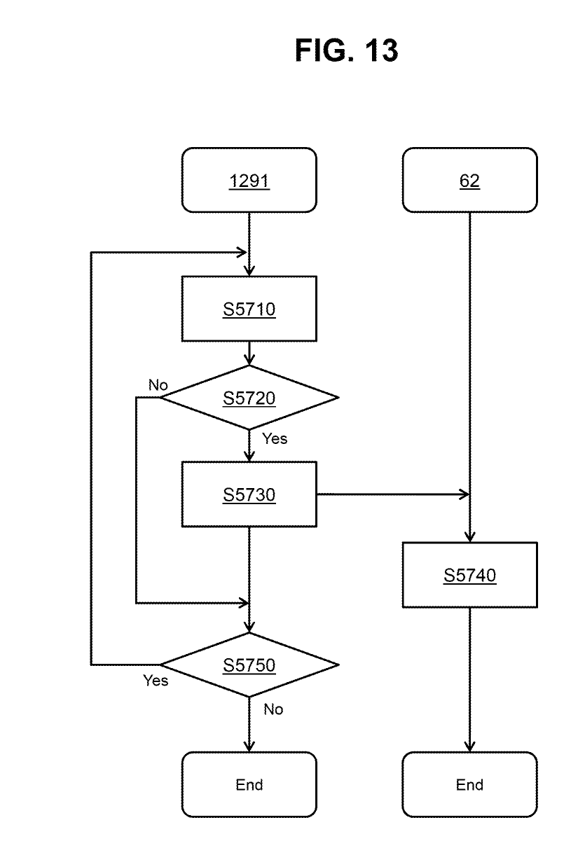

FIG. 13 is a flowchart of the C-snap (sorting). S5710 is performed. That is, the C-snap program 1291 specifies the S-meta pointer 1254 corresponding to the root ID designated by the instruction from the user from the storage management table 1250. Subsequently, the C-snap program 1291 refers to the S-meta management information 1210 from the specified S-meta pointer 1254 and specifies the C-meta 83 associated with the S-meta from the user ID 121011 and the user pointer 121011 of the S-meta management information 1210.

Subsequently, the C-snap program 1291 determines whether the C-meta 83 (the content information included in the C-meta 83) is suitable for the search key designated by the user (S5720).

When the determination result S5720 is true (S5720: Yes), the C-snap program 1291 requests the object program 62 to copy the first S-meta 82S (the S-meta management information 1210 and the S-meta attribute information 1220) associated with the C-meta 83 (S5730). In response to the request, the object program 62 copies the designated first S-meta 82S (S5740). During the copying, an S-meta ID different from the S-meta ID of the original first S-meta 82S may be assigned as the S-meta ID of the second S-meta 82T based on a copy of the first S-meta 82S. Moreover, during the copying, any one of the C-snap program 1291 and the object program 62 may execute a copying narrowing process which is any one of (a) and (b) below.

(a) Copying of the S-meta attribute information 1220 that refers to the data chunk unnecessary for analysis (the S-meta attribute information 1220 of the reference destination of the C-meta 83 that is not suitable for the search key) is skipped.

(b) The data validity 122007 of the S-meta attribute information 1220 is changed to “NO”.

Whether such a copying narrowing process will be executed or not may be described in the instruction from the user (the instruction to start the C-snap program 1291). By the copying narrowing process, it is possible to narrow down the data chunk 81 included in the SSVOL 26S (VDM).

Subsequently, the C-snap program 1291 determines whether S5710 will be performed for all pieces of first S-meta 82S corresponding to the root ID designated from the user (S5750). When the determination result in S5750 is false (S5750: No), S5710 is performed on non-processed S-meta 82. When the determination result in S5750 is true (S5750: Yes), the process ends. When S5740 is performed on at least one piece of first S-meta 82S, the C-snap (snap acquisition) is performed.

### <(2-2) C-Snap (Snap Acquisition)>

The SSVOL 26S is created on the basis of the second S-meta 82T obtained in the C-snap (sorting). This SSVOL 26S is provided to the host computer 200 whereby the host computer 200 can use the SSVOL 26S as the DM.

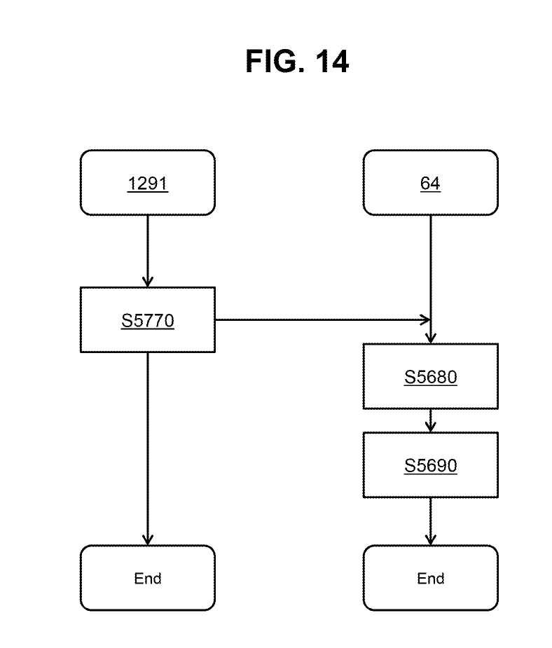

FIG. 14 is a flowchart of the C-snap (snap acquisition).

The C-snap program 1291 requests the snapshot program 64 to create a snapshot (S5770). Here, during creation of the snapshot, the C-snap program 1291 passes the S-meta ID of the second S-meta 82T created by the C-snap (sorting) to the snapshot program 64.

In response to this request, the snapshot program 64 specifies the S-meta management information 1210 that matches the S-meta ID passed from the C-snap program 1291 and changes the copy state 122003 of the S-meta attribute information 1220 associated with the S-meta management information 1210 to “SVOL” (S5680). When the copy state 122003 is changed to “SVOL”, write data is determined to be snapshot target data when writing data to the object and a necessary snapshot process (see FIG. 4) is performed.

Subsequently, the snapshot program 64 adds a copy destination root ID (the ID of the SSVOL 26S) designated by the user to the storage management table 1250 as the root ID 1251 and associates the pointer 1254 to the second S-meta 82T with the root ID 1251 (S5690). The snapshot program 64 may provide the copy destination root ID (the SSVOL 26S) to the host computer 200 of the user (a retrieval request source user) who issued a C-snap start instruction.

As described above, in the C-snap process of the storage apparatus 300, a snapshot target data chunk (a data chunk included in a VDM) is sorted on the basis of the search key provided from the user during the C-snap (sorting), and the SSVOL 26S (VDM) including the sorted data chunk is created during the C-snap (snap acquisition).

In principle, a plurality of copy destination root IDs (SSVOLs 26S) can be created for one root ID (the data VOL 26D). Specifically, a plurality of SSVOLs 26S can be created for one data VOL 26D, for example.

After the C-snap process is performed, when the host computer 200 accesses the copy destination root ID designated during creation of the C-snap, it appears as if the DM (the SSVOL 26S) is present when seen from the host computer 200. When a plurality of SSVOLs 26S are created, it appears as if DMs (data marts) of different view points are created.

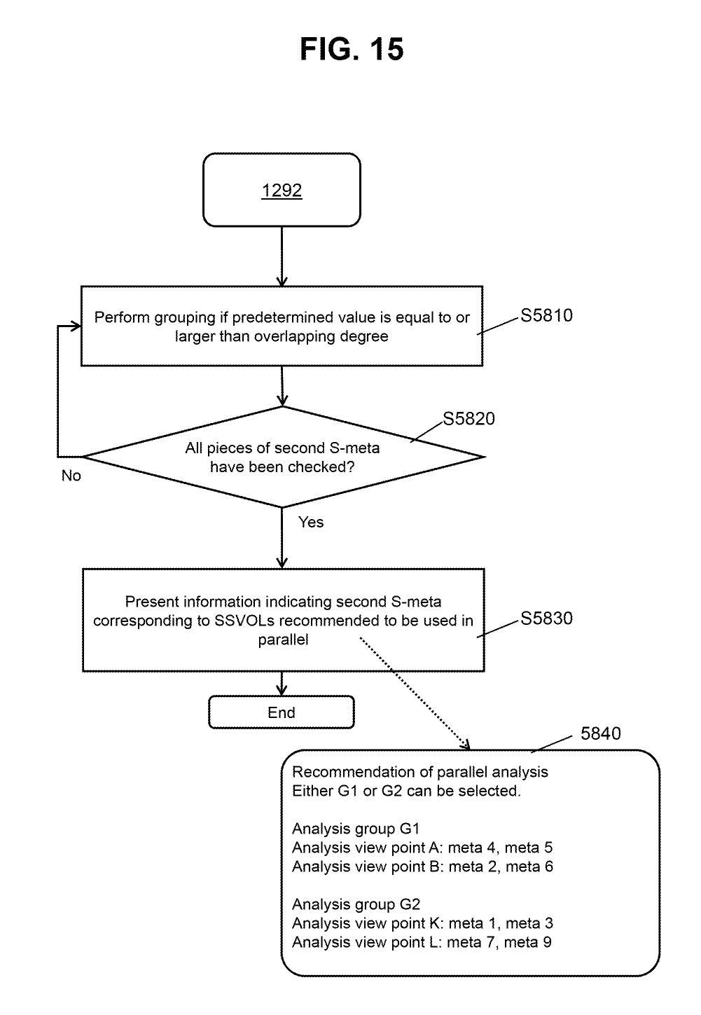

FIG. 15 is a flowchart of an overlap checking process.

The overlap checking process is executed by the overlap checking program 1292. The overlap checking process is a process including creation of the analysis group and presentation of the recommendation information described above. The overlap checking program 1292 is a program that constructs an analysis group including two or more pieces of second S-meta 82T having an overlapping degree equal to or larger than a threshold and presents information indicating the second S-meta 82T (and the SSVOL 26S corresponding to the second S-meta 82T) included in the analysis group. The overlap checking process may start in response to one or more user requests that designate a plurality of analysis view points or may start when a predetermined overlap checking start event is detected (for example, periodically) without receiving such a user request. In this overlap checking process, the analysis group constructed in the previous overlap checking process may be updated, or all analysis groups constructed in the previous overlap checking process may be removed to newly update analysis groups.

The overlap checking program 1292 executes S5810. That is, the overlap checking program 1292 selects one metaset. The “metaset” is a set of one piece of C-meta 83 and one piece of second S-meta 82T. The metaset is selected from one or more metasets which are not included in any analysis group. Subsequently, the overlap checking program 1292 calculates an overlapping degree between a reference destination (an address range) indicated by the selected metaset and the reference destinations indicated by all metasets other than the selected metaset. The “reference destination indicated by the metaset” is a reference destination (an address range) indicated by the starting address 122005 and the ending address 122006 of all pieces of S-meta attribute information 1220 included in the second S-meta 82T in the metaset. Hereinafter, the selected metaset will be referred to as a “comparison source metaset” and a metaset other than the comparison source metaset will be referred to as a “comparison destination metaset”. The overlap checking program 1292 specifies a comparison destination metaset of which the overlapping degree with respect to the comparison source metaset is equal to or larger than the threshold. The overlap checking program 1292 groups the comparison source metaset and the specified comparison destination metaset (that is, the comparison destination metaset of which the overlapping degree with respect to the comparison source metaset is equal to or larger than the threshold) to construct one analysis group. The “threshold” of the overlapping degree may be set in advance, may be set by the user, may be a fixed value, and may be a variable value. In S5810, when the overlapping degree between the comparison source metaset and any comparison destination metaset is smaller than the threshold, an analysis group including the comparison source metaset only may be constructed. Alternatively, in S5810, when the overlapping degree between the comparison source metaset and any comparison destination metaset is smaller than the threshold, the comparison source metaset may be grouped with K (K is a natural number) comparison destination metasets (for example, a comparison destination metaset having the highest overlapping degree) having the higher overlapping degrees among one or more comparison destination metasets.

The overlap checking program 1292 determines whether S5810 has been executed for all pieces of second S-meta 82T (S5820). When the determination result in S5820 is false (S5820: No), S5810 is executed again.

When the determination result in S5820 is true (S5820: Yes), all metasets belong to any one of the analysis groups Gn (n is a natural number). The overlap checking program 1292 presents recommendation information (S5830). Specifically, for example, the overlap checking program 1292 presents information (for example, the S-meta 121001) indicating the second S-meta 82T corresponding to the SSVOLs 26S recommended to be used in parallel. The information indicating the second S-meta 82T is presented for each analysis group (reference numeral 5840 is an example of a presentation screen on which the information indicating the second S-meta 82T is presented for each analysis group). The analysis group is typically a high-overlapping-degree analysis group (an analysis group which includes two or more second S-meta 82T of which the overlapping degree is equal to or larger than the threshold and which do not include two or more second S-meta 82T of which the degree of overlap is smaller than the threshold). Therefore, by performing a plurality of analyses belonging to the analysis group in parallel (for example, simultaneously), the probability (a cache hit rate) that an overlapping data chunk is present in a cache memory increases and an access to the PDEV 1500 can be reduced.

In S5830, the overlap checking program 1292 can narrow the presentation target analysis groups among the constructed one or more analysis groups on the basis of the configuration management table 1240.

For example, a number of analysis groups with which data chunk groups to be referred to can be executed in parallel may be selected as a presentation target on the basis of the resource type 12401, the resource ID 12402, the related resource 12403, and the specification 12404 represented by the configuration management table 1240.

Moreover, the overlap checking program 1292 may select an analysis group which is a small-capacity analysis group (an analysis group that refers to a data chunk group having a capacity equal to or smaller than the capacity of a cache memory indicated by the configuration management table 1240) as a presentation target.

Moreover, the overlap checking program 1292 may select an analysis group which is a low-overlapping-degree analysis group as the presentation target instead of an analysis group which is a high-overlapping-degree analysis group and a large-capacity analysis group. That is, the overlap checking program 1292 may execute the process (s) described with reference to FIG. 1. In this way, it can be expected that accesses to the PDEV 1500 are distributed to a plurality of PDEVs 1500.

According to Embodiment 1, the storage controller 329 creates the C-meta 83 including one or more content attributes indicated by the data chunk 81 with respect to the data chunk 81 and associates the C-meta 83 with the first S-meta 82S of the data chunk 81. The target of the retrieval corresponding to the retrieval request that designates the search key is not the data chunk 81 but the C-meta 83. The storage controller 329 generates the second S-meta 82T by copying the first S-meta 82S associated with the found C-meta 83 and constructs the SSVOL 26S to which the second S-meta 82T belongs. In this way, the DM (VDM) is created without copying the data chunk 81. The storage controller 329 constructs an analysis group including the second S-meta 82T of which the overlapping degree is equal to or larger than the threshold and presents information indicating the second S-meta 82T (and/or the SSVOL 26S corresponding to the second S-meta 82T) included in the constructed analysis group. The overlapping data chunk referred to by the second S-meta 82T having the overlapping degree equal to or larger than the threshold is a data chunk which can be referred to highly frequently. Therefore, it is possible to execute parallel analog signal while avoiding accesses to the PDEV 1500 within the storage apparatus 300 as much as possible.

In Embodiment 1, the overlap checking program 1292 may specify the capacity of the cache memory from the configuration management table 1240 during construction of the analysis group and construct the small-capacity analysis group only.

### Embodiment 2

Embodiment 2 will be described. The difference from Embodiment 1 will be described mainly and the description of features common to Embodiment 1 will be omitted or simplified. This is true to the other embodiments.

In Embodiment 2, a plurality of analyses using a plurality of VDMs (SSVOLs 26S) are distributed to a plurality of storage apparatuses 300. Specifically, in Embodiment 2, after processes up to the extraction process and the C-snap (sorting) are performed, a creation destination storage apparatus of the C-snap (SSVOL 26S) is selected from a plurality of storage apparatuses before the C-snap (snap acquisition) is performed. After the storage apparatus is selected, the selected storage apparatus performs creation of the C-snap and the overlap checking process.

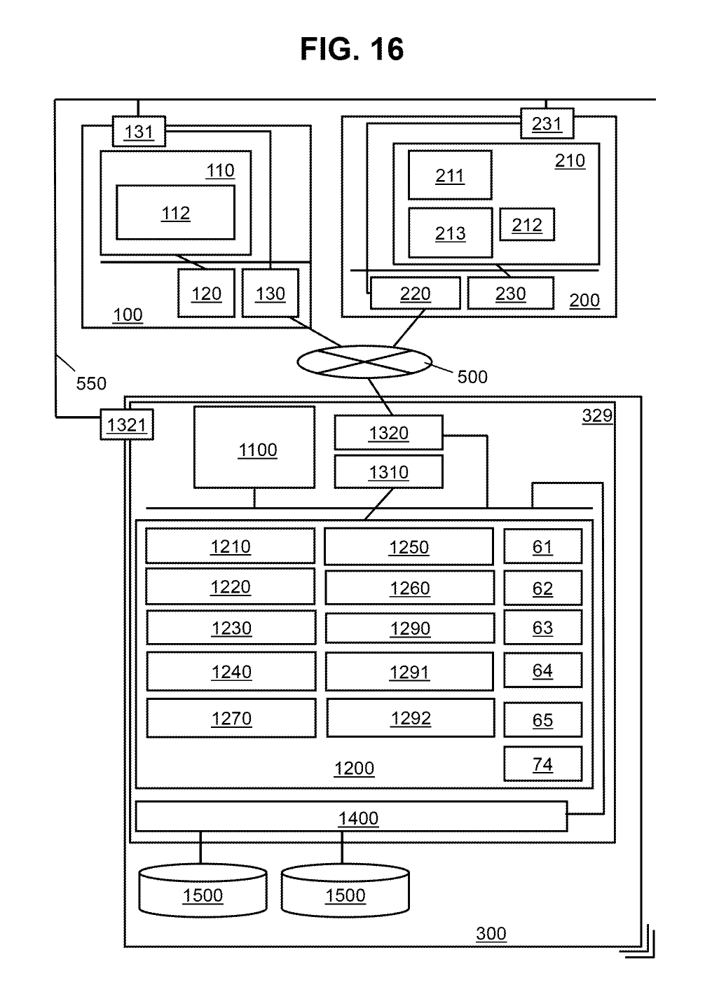

FIG. 16 is a block diagram of a computer system according to Embodiment 2.

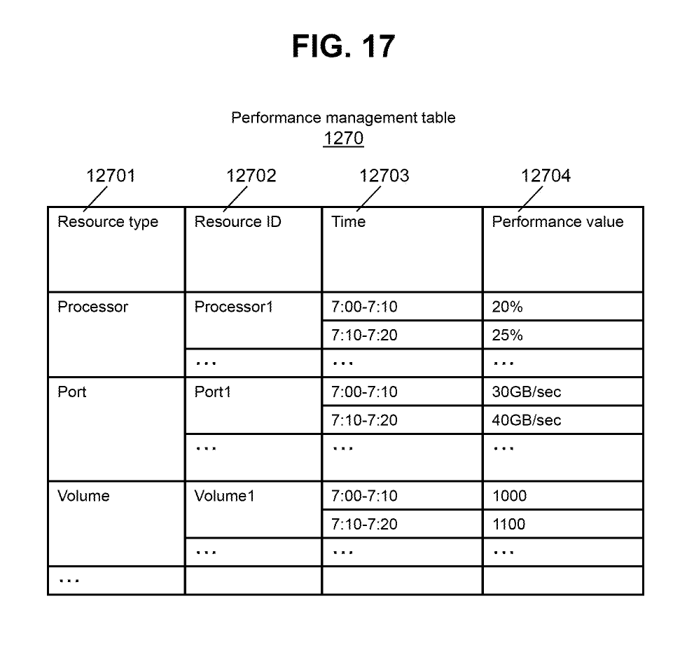

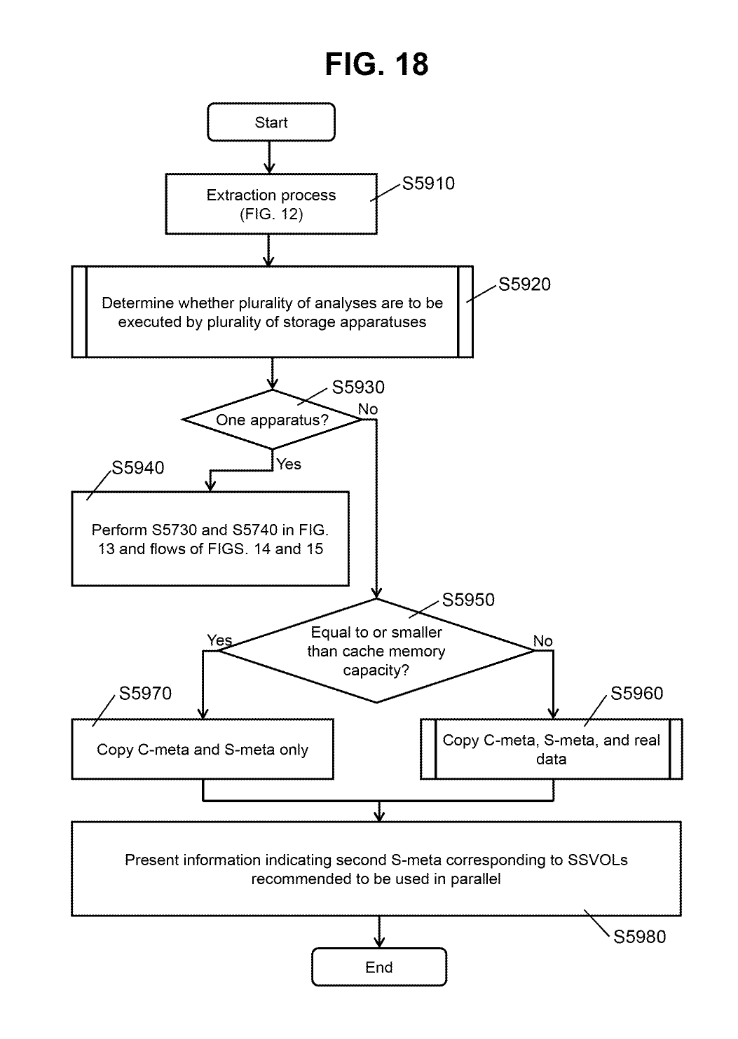

This computer system includes a plurality of storage apparatuses 300. In each storage apparatus 300, a local memory 1200 stores a performance management table 1270, a copy program 65, and a scale-out program 74. The performance management table 1270 is a table that stores information indicating the performance of resources in the storage apparatus 300 (the details of this table will be described in FIG. 17). The copy program 65 executes copying between the storage apparatuses 300. The scale-out program 74 executes exchanging of I/O requests between the storage apparatuses 300.

The management computer 100 can collect information stored in the configuration management table 1240 and the performance management table 1270 from the plurality of storage apparatuses 300 and store the collected information in a memory 110. That is, the management computer 100 can aggregate the configuration management tables 1240 and the performance management tables 1270 of the plurality of storage apparatuses 300 into the memory 110 of the management computer 100. The management computer 100 may collect the information periodically from the plurality of storage apparatuses 300 and may collect the information from the storage apparatus 300 upon receiving a notification indicating that information is changed from the storage apparatus 300. The functions of the management computer 100 may be included in a computer independent from the host computer 200 and the storage apparatus 300 and may be included in either the storage apparatus 300 or the host computer 200. Moreover, rather than the management computer 100 collecting the information of the configuration management tables 1240 and the performance management tables 1270 of all storage apparatuses 300, each storage apparatus 300 may collect information from all storage apparatuses 300 other than the subject storage apparatus 300.

FIG. 17 illustrates a configuration of the performance management table 1270.

The performance management table 1270 has records for each resource. Each record stores information including a resource type 12701, a resource ID 12702, a time 12703, and a performance value 12704.

The resource type 12701 is information indicating the type of a resource (component) in the storage apparatus 300. The resource ID 12702 is information indicating an identifier of the resource.

The time 12703 is information indicating an acquisition time of performance information including the performance value indicated by the corresponding performance value 12704. According to the example of FIG. 17, although the performance information of “Processor1” is acquired every 10 minute, a time interval for acquiring the performance information can be set arbitrarily. Moreover, the latest performance information only may be stored in the performance management table 1270.

The performance value 12704 is information indicating the acquired performance value. When the resource type is “Processor”, the performance value 12704 indicates a CPU usage rate. The unit of the performance value indicated by the performance value 12704 may be different depending on the resource type 12701. A plurality of types of performance values may be included in the performance value 12704 for one resource type. When the latest performance value only rather than the performance value of each time period is stored as the performance value 12704, the performance value 12704 may be an accumulated value and may be a value per unit time. For example, as the performance value 12704 of Volume, an accumulated value (for example, a counted value of the number of I/O requests) may be stored and a value per unit time (for example, IOPS (the number of I/O requests per second)) may be stored.

FIG. 18 is a flowchart of an entire process from an extraction process to an overlap checking process.

First, the extraction process is the process illustrated in FIG. 12 (S5910).

Subsequently, the management program 112 of the management computer 100 determine whether a plurality of analyses will be executed by one storage apparatus 300 having the data VOL 26D (the data source) or two or more storage apparatuses 300 on the basis of a plurality of search keys (a plurality of analysis view points) passed from the analysis application 211 of the host computer 200 via the agent program 213 and the configuration management table 1240 and the performance management table 1270 of each storage apparatus 300 (S5920).

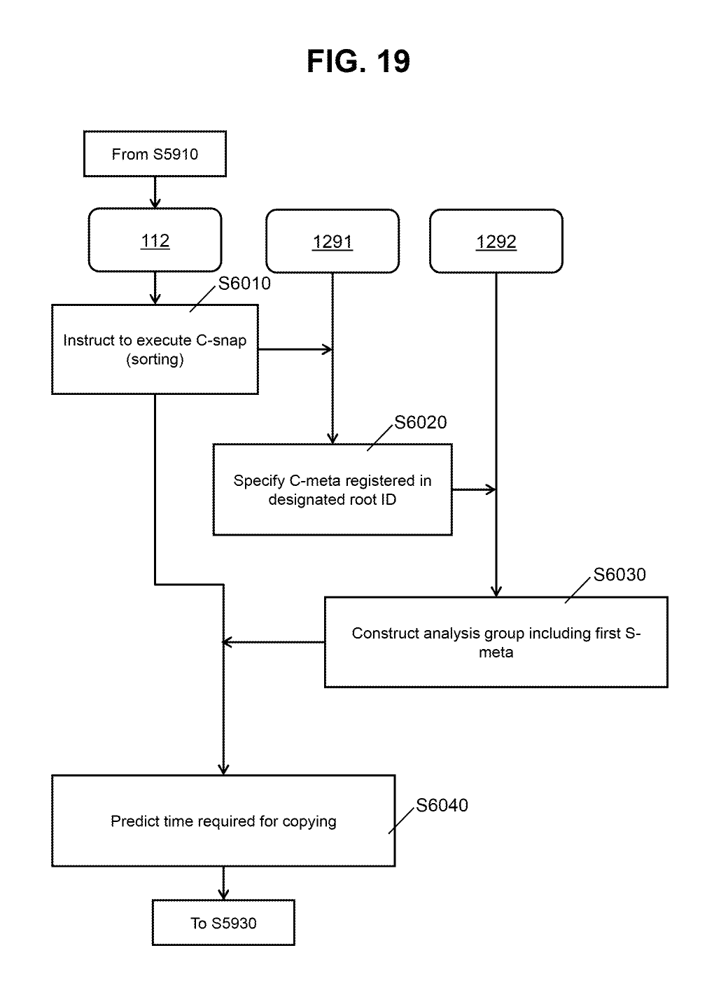

FIG. 19 is the flowchart of S5920.

The management program 112 instructs the storage apparatus 300 having the data VOL 26D to perform C-snap (sorting) (S6010). A root ID is designated in this instruction. The C-snap program 1291 in the storage apparatus 300 having received this instruction executes the same processes as S5710 and S5720 (YES) in FIG. 13 (S6020). That is, the C-snap program 1291 specifies the S-meta pointer 1254 corresponding to the designated root ID from the storage management table 1250. The C-snap program 1291 specifies the C-meta 83 corresponding to any one of the search keys received in S5920 among the pieces of C-meta 83 associated with the first S-meta 82S specified from the specified S-meta pointer 1254.

Subsequently, the overlap checking program 1292 calculates the overlapping degree of two or more pieces of first S-meta 82S using the starting address 122005 and the ending address 122006 of a plurality of pieces of first S-meta 82S associated with the plurality of pieces of C-meta 83 specified in S6020 and constructs one or more analysis groups on the basis of the overlapping degree (S6030). This is substantially the same process as S5810 in FIG. 15. Specifically, in S5810, the analysis group of the metaset including the second S-meta 82T is constructed. However, in S6030, the analysis group of the metaset (the set of the C-meta 83 and the first S-meta 82S) including the first S-meta 82S is constructed. The overlap checking program 1292 returns the result (for example, information on the constructed analysis group) of S6030 to the management program 112.

The management program 112 having received the result predicts the time required for copying on the basis of the association between the first S-meta 82S and the C-meta 83, the capacity of the SSVOL associated with the first S-meta 82S and the C-meta 83, and the configuration management table 1240 (S6040). Here, the “SSVOL capacity” may be a total capacity of one or more data chunks corresponding to one or more pieces of C-meta 83 specified among the data chunk group referred to by the first S-meta 82S associated with the specified one or more pieces of C-meta 83.

The time required for copying may be predicted as follows, for example. The management program 112 searches for a combination in which the sum of the time required for a read process of analyses and the time required for copying is minimized using the analysis groups G1, G2, . . . , and Gn constructed in S6030. If the time required for a read process of analyses of a copy source is Tsr and the CPU time is evenly allocated to one VDM (DM),

Tsr(Time required for read process of analysis of one VDM)=(VDM capacity)/((Read performance on catalog of copy source storage apparatus)/Ndm).

Moreover, if a copying time of a copy source (data transfer time) is Tsc,

Tsc=(Capacity of Sx volume excluding overlapping)/((Read performance on catalog of copy source storage apparatus)/Ndm).

Therefore,

Ttc(Copying time of copy destination)=(Capacity of VOL for Gx excluding overlapping)/(Write performance on catalog of copy destination storage apparatus).

Moreover, it is considered that

Ttr (Time required for read process of analyses in copy destination)=(Capacity of VDM for Gx)/((Read performance on catalog of copy destination storage apparatus)/Number of VOLs for Gx) is established. Here, “Ndm” means (number of VDMs that are not copied)+(number of Gxs excluding overlapping). “Gx” means a set of analysis groups of the C-meta 83 and the first S-meta 82S. Moreover, the “copy destination storage apparatus” may be a storage apparatus that satisfies conditions that it has a vacant capacity capable of storing information in the analysis group and that a CPU usage rate and a cache usage rate are lower than those of a copy source storage apparatus and may be a storage apparatus that satisfies other conditions. The sum Tsum of all processing times is Tsum=Max(Σ(Tsr), Σ(Tsc+Ttc+Ttr)). Here, “Max(X,Y)” is the value of the larger one of X and Y. Therefore, the management program 112 searches for a combination in which Tsum is minimized. When any of the grouped metasets of the C-meta 83 and the first S-meta 82S is not copied, although Tsc, Ttc, and Ttr are 0, since the number of VDMs is large, the CPU time allocated to one VDM is small and Tsr for one VOL increases. As a result, Tsr for all VDMs increases. When Gy (y is a natural number) which is a group having the highest overlapping degree is copied, Tsr decreases and Tsc, Ttc, and Ttr increase. When the copy destination is distributed to two or more storage apparatuses, Σ(Ttc+Ttr) can be decreased even when the number of copied analysis groups G increases. When this repeated calculation is performed while increasing the number of analysis groups in descending order of overlapping degrees (when the number of copied analysis groups is increased), it is possible to find Tsum which is minimized. This calculation is an example and other optimization methods may be used.

Description will be continued with reference to FIG. 18. Since the result of S5920 (the result of FIG. 19) shows that the analyses are to be executed by one storage apparatus when it is not necessary to copy any one of the analysis groups, the flow proceeds to S5940. In S5940, S5730 and S5740 in FIG. 13 of Embodiment 1 are performed with respect to all view points, and after that, the processes of FIGS. 14 and 15 are performed.

On the other hand, when the result of S5920 (the result of FIG. 19) shows that at least one analysis group is copied, the flow proceeds to S5950. In S5950, the management program 112 determines whether the capacity excluding overlapping of the analysis group Gy to be copied ascertained in S5920 is equal to or smaller than the capacity of the cache memory of the copy destination storage apparatus.

When the determination result in S5950 is true (S5950: Yes), the C-meta 83 and the first S-meta 82S only are copied (S5970). On the other hand, when the determination result in S5950 is false (S5950: No), the real data (data chunk) as well as the C-meta 83 and the first S-meta 82S are also copied (S5960).

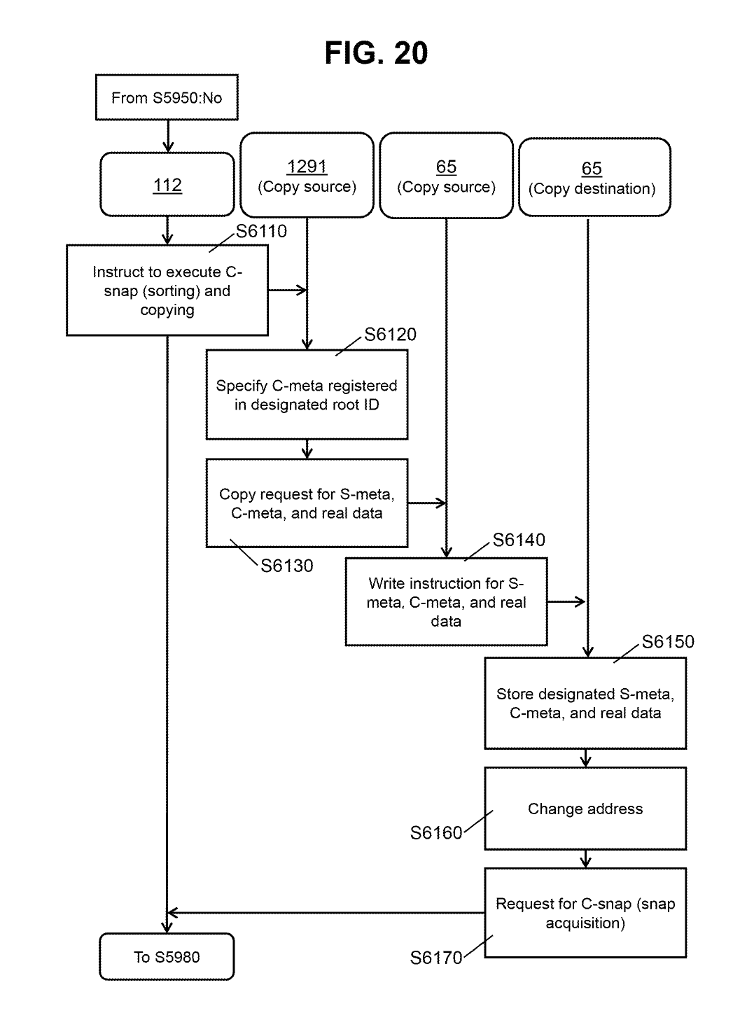

FIG. 20 is a flowchart of S5960.

The management program 112 instructs the copy source storage apparatus 300 (typically the storage apparatus 300 having the data VOL 26D) to perform C-snap (sorting) and copying (S6110). In this instruction, the root ID and the information of the copy destination storage apparatus (for example, the storage ID 1252 of the copy destination storage apparatus) are designated.

The C-snap program (hereinafter a copy source C-snap program) 1291 in the copy source storage apparatus 300 having received the instruction executes the same processes as S5710 and S5720 (YES) in FIG. 13 (S6120). That is, the copy source C-snap program 1291 specifies the S-meta pointer 1254 corresponding to the designated root ID from the storage management table 1250. The copy source C-snap program 1291 specifies the C-meta 83 corresponding to any one of the search keys received in S5920 among the pieces of C-meta 83 associated with the first S-meta 82S specified from the specified S-meta pointer 1254.

Subsequently, the copy source C-snap program 1291 sends a copy request to the copy program (hereinafter a copy source copy program) 65 in the copy source storage apparatus 300 designated by the instruction received in S6120 to copy the specified C-meta 83, the first S-meta 82S associated thereto, and the real data corresponding to the C-meta 83 and the first S-meta 82S (S6130). In response to the copy request, the copy source copy program 65 sends a write instruction to the copy destination storage apparatus 300 designated by the copy request to write the first S-meta 82S and the C-meta 83 designated by the copy request and the real data corresponding thereto (S6140).

In response to the write instruction, the copy program (hereinafter a copy destination copy program) 65 in the copy destination storage apparatus 300 stores the first S-meta 82S and the C-meta 83 designated by the write instruction and the real data corresponding thereto in the copy destination storage apparatus 300 (S6150). The storage destination of the first S-meta 82S and the C-meta 83 may be the local memory 1200 of the copy destination storage apparatus 300. Moreover, the first S-meta 82S to be stored may be the second S-meta 82T based on a copy of the first S-meta 82S. The storage destination of the real data may be the data VOL provided by the copy destination storage apparatus 300. The data VOL may be an RVOL (real VOL) or a TPVOL (a virtual logical volume based on Thin Provisioning). As described above, at the time point of S6150, the C-meta 83 corresponding to the write instruction, the second S-meta 82T based on a copy of the first S-meta 82S corresponding to the write instruction, and the real data (one or more data chunks) are stored.

Subsequently, the copy destination copy program 65 rewrites the reference destination address corresponding to the stored real data, that is, the reference destination address (the starting address 122005 and the ending address 122006) of the stored second S-meta 82T and the reference destination address (the starting address 123003 and the ending address 123004) of the stored C-meta 83, to the address of the area in which the real data is stored (S6160).

After that, the copy destination copy program 65 requests the C-snap program (hereinafter a copy destination C-snap program) 1291 in the copy destination storage apparatus 300 to perform C-snap (snap acquisition) (S6170). In the C-snap (snap acquisition) performed by the copy destination C-snap program 1291 in response to this request, the SSVOL 26S corresponding to the stored second S-meta 82T is created. After that, the management program 112 is notified of completion of the C-snap (snap acquisition).

After the above-described processes are performed, the flow proceeds to S5980. In S5980, the management program 112 performs the same process as S5830 in FIG. 15.

In S5980, the first S-meta 82S in the analysis group may be replaced with the second S-meta 82T stored in the copy destination storage apparatus.

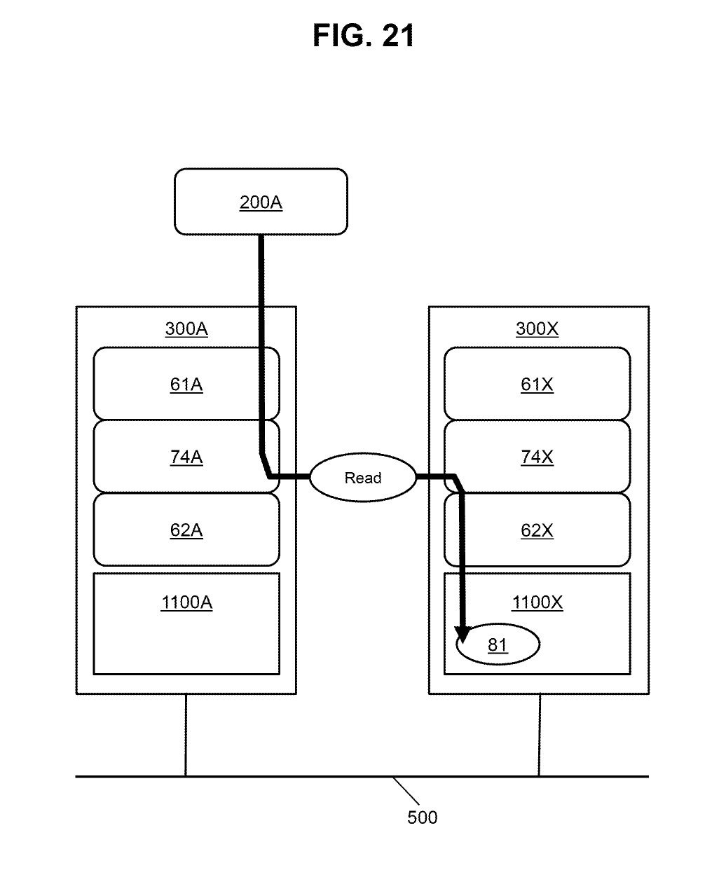

Moreover, the process of S5970 illustrated in FIG. 18 is the same as the process of S5960 except that the real data is not present (for example, no copying of real data and no change in the reference destination address). Due to this, the C-meta 83 and the second S-meta 82T stored in the copy destination storage apparatus 300 indicate the address of the area of the data VOL 26D of the copy source storage apparatus 300. In this case, a scale-out process is required to realize data access. FIG. 21 illustrates an overview of a scale-out process. In FIG. 21, storage apparatuses 300X and 300A are illustrated. Scale-out programs 74X and 74A are added to the storage apparatuses 300X and 300A, respectively. For example, the scale-out program 74X (74A) may relay cooperation between an I/O program 61X (61A) and an object program 62X (62A). Cache memories 1100X and 1100A are present in the storage apparatuses 300X and 300A, respectively.

Here, when the storage apparatus 300A receives a read request from the host computer 200A, the scale-out program 74A of the storage apparatus 300A determines whether a destination of the read request is the storage apparatus 300A. When the determination result is false, the scale-out program 74A sends the read request to the storage apparatus 300X which is a destination of the read request. The storage apparatus 300X having received the sent read request reads the data chunk 81 into the cache memory 1100X on the basis of the read request.

For example, processes subsequent to S5020 in the flowchart of FIG. 10 are different from those of Embodiment 1. Specifically, for example, the scale-out program 74A acquires a common request and determines whether an access destination of the common request is the storage apparatus 300A. When the determination result is false, the scale-out program 74A sends the common request to the scale-out program 74X of the storage apparatus 300X which is an access destination of the common request. The scale-out program 74X passes the common request to the object program 62X. On the other hand, when the access destination of the common request is the storage apparatus 300A, the scale-out program 74A passes the common request to the object program 62A of the storage apparatus 300A.

For example, the processes subsequent to S5520 in the flowchart of FIG. 11 are different from those of Embodiment 1. Specifically, for example, the scale-out program 74A acquires a common request and determines whether an access destination of the common request is the storage apparatus 300A. When the determination result is false, the scale-out program 74A sends the common request to the scale-out program 74X of the storage apparatus 300X which is an access destination of the common request. The scale-out program 74X passes the common request to the object program 62X. On the other hand, when the access destination of the common request is the storage apparatus 300A, the scale-out program 74A passes the common request to the object program 62A of the storage apparatus 300A.

As described above, according to Embodiment 2, it is possible to realize the C-snap process across a plurality of storage apparatuses 300. As a result, for example, the storage apparatus 300A stores data only and the storage apparatus 300B stores snapshot data only, and in this way, the usage of these storage apparatuses can be distinguished according to purposes. Therefore, influence on performance by VDM analysis of a specific storage apparatus does not have an impact on the performance of other storage apparatuses.

According to Embodiment 2, since a plurality of SSVOLs are disposed in the plurality of storage apparatuses 300, it is possible to distribute a plurality of analyses to the plurality of storage apparatuses 300. In this way, it can be expected that the time required for a plurality of analyses can be shorted.

Copying between storage apparatuses 300 may be performed in units of analysis groups and may be performed in units of metasets included in the analysis group. In the latter case, selection of a copy target metaset may end when a value obtained by subtracting the capacity of a data chunk group referred to by a copy target metaset from the capacity of the data chunk group referred to by the analysis group is equal to or smaller than the capacity of the cache memory of the copy source storage apparatus 300.

### Modification 1 of Embodiment 2

In Modification 1 of Embodiment 2, after analysis ends (for example, after “(3) Analysis” in FIG. 2 ends), it is determined whether stored information (at least one of the second S-meta 82T, the C-meta 83, and the real data) will be removed from the copy destination storage apparatus. For example, after the C-meta 83 suitable for a certain search key is specified, if the same C-meta 83 is specified by the same search key within a predetermined period, the C-meta 83, the second S-meta 82T associated with the C-meta 83, and the real data corresponding thereto may not be removed from the copy destination storage apparatus. The designated search key and a C-meta specifying time point (the time point at which the C-meta 83 was specified) may be stored in the user extension 123006 of the C-meta management information 1230 of the specified C-meta 83 or may be stored in other locations. Hereinafter, a specific example will be described.

In S6020 of FIG. 19, the C-snap program 1291 registers the designated search key and the time point at which the C-meta 83 was specified in the user extension 123006 of the C-meta management information 1230 of the specified C-meta 83. When the same search key and the copy destination storage information (the information indicating the copy destination storage apparatus, for example, a storage ID) are already registered in the user extension 123006 of the C-meta management information 1230 of the specified C-meta 83, the C-meta specifying time point in the user extension 123006 is updated. The C-snap program 1291 does not copy the C-meta 83 including the copy destination storage information, the first S-meta 82S associated with the C-meta 83, and the corresponding real data again in the subsequent processes. The C-snap program 1291 performs processes subsequent to S5930 with respect to the C-meta 83 and the like that do not include the copy destination storage information and adds the copy destination storage information to the user extension 123006 of the copy target C-meta 83 during copying.

Moreover, the management program 112 periodically examines the C-meta management information 1230 of each storage apparatus 300, removes the C-meta 83 which has elapsed a predetermined period (which may be a fixed value or may be set by a user) or longer from the last C-meta specifying time point, the second S-meta 82T associated with the C-meta 83, and the real data and the SSVOL 26S corresponding thereto from the storage apparatus 300, and removes the search key, the C-meta specifying time point, and the copy destination storage information from the user extension 123006 of the copy source C-meta 83.

By the above-described processes, it is possible to avoid the C-meta 83 and the like stored in the copy destination storage apparatus from remaining in an unused state. Moreover, since the C-meta 83 and the like to be used for repeated analysis remain in the copy destination storage apparatus 300, it is not necessary to copy the C-meta 83 and the like.

### Modification 2 of Embodiment 2

In Modification 2 of Embodiment 2, instead of selecting a copy destination storage apparatus when predicting the time required for copying and preparing an SSVOL in the copy destination storage apparatus before a plurality of analysis are executed, the storage apparatus 300 monitors the performance management table 1270 while executing a plurality of analyses corresponding to an analysis group in parallel and copies the C-meta 83 and the like corresponding to an analysis which has not been executed among the plurality of analyses corresponding to the analysis group to another storage apparatus 300 when resource depletion occurs. The “resource depletion” means that a performance value of a resource reaches a threshold (for example, a cache memory usage rate or a CPU usage rate reaches a threshold). Moreover, even when a plurality of analyses are performed in parallel, it cannot be said that all analyses start simultaneously.

In Modification 2, the following processes are performed, for example. That is, S5920 and S5930 in FIG. 18 are not performed, and S5940 is performed. The storage controller 329 performs a plurality of analyses using the plurality of SSVOLs 26S (VDMs) corresponding to the analysis group presented by the process of FIG. 15 in parallel. During analysis, the management program 112 periodically checks the performance management table 1270 to determine whether resource depletion has occurred. When occurrence of resource depletion is detected and an SSVOL corresponding to an unexecuted analysis among the plurality of analyses is present, the storage controller 329 copies the second S-meta 82T and the like to another storage apparatus in descending order of the overlapping degrees of the unexecuted analyses. The flow of the series of copying processes may be the same as the processes subsequent to S5950 in FIG. 18.

According to Modification 2, a plurality of analyses using the plurality of SSVOLs 26S of the storage apparatus 300 are executed in parallel, and when resource depletion occurs only, the SSVOL 26S and the like corresponding to an unexecuted analysis is copied to another storage apparatus 300.

While several embodiments and modifications thereof have been described, the present invention is not limited to these embodiments and the modifications, and various changes can naturally be made without departing from the spirit thereof.

For example, two or more examples among the embodiments and the modifications may be combined.

In the embodiments and modifications, although a storage system is an example of a data processing system, the data processing system may correspond to at least one of a storage system, a host system, and a management system. For example, when the host system corresponds to the data processing system, a sender that sends a retrieval request that designates a search key to the host system may be a client system (one or more client computers).

In the embodiments and modifications, although the C-meta 83 as well as the S-meta 82 are present in the storage system, the C-meta 83 may be present in the host system or the management system instead of or in addition to the storage system. Specifically, the C-meta 83 may be created for each user (for example, for each host system or each management system) with respect to the same object (the same data chunk 81), and the C-meta 83 may be provided to a host system or a management system of the user corresponding to the C-meta 83. When the host system or the management system receives designation of a retrieval condition from the user, a processor in the host system or the management system may search for the C-meta 83 suitable for the retrieval condition among pieces of C-meta 83 corresponding to the user from the host system or the management system. When the C-meta 83 is found, the host system or the management system may request the storage system to create an SSVOL to which the S-meta 82 referred to by the C-meta 83 belongs. The storage system may execute a C-snap process in response to this request.

The C-meta 83 may be present for each user. For example, for the same data chunk 81, the C-meta 83 created by the extraction program 1290 of user A may be stored as the C-meta 83 for user A, and the C-meta 83 created by the extraction program 1290 of user B may be stored as the C-meta 83 for user B. Upon receiving a retrieval request from user A, the storage controller 329 (the C-snap program 1291) may search for the C-meta 83 suitable for the search key designated by the retrieval request and the user A who is the requesting source. Moreover, when the C-snap program 1291 of the user A is present as the C-snap program 1291, the C-snap program 1291 of the user A may search for the C-meta 83 suitable for the user A and the search key designated by the retrieval request from the user A.

The C-snap process may start when a C-snap event which is a predetermined event defined to start a C-snap process is detected. The C-snap event may be reception of a user request (for example, an explicit request for the C-snap process or a request in which execution of the C-snap process is defined), arrival of a predetermined time point (for example, execution of the C-snap process starts periodically), or a predetermined performance state (a state related to performance) such as a state in which the load of a processor executing the C-snap program 1291 is lower than a predetermined value. For example, the storage controller 329 may receive a user request from at least one of the management computer 100 and the host computer 200 and execute the C-snap process in response to the user request.

The user program (for example, at least one of the extraction program 1290, the C-snap program 1291, and the overlap checking program 1292) may be executed by any one of the management computer 100, the host computer 200, and the storage controller 329.

The SSVOL 26S (VDM) may be updated periodically or non-periodically. For example, the C-snap program 1291 may specify the C-meta 83 indicating the same content attribute as the content attribute indicated by the C-meta 83 associated with the second S-meta 82T to which an existing SSVOL 26S belongs, create new second S-meta 82T by copying the first S-meta 82S referred to by the C-meta 83, and associate the new second S-meta 82T with the existing SSVOL 26S.

Moreover, a file may be employed as an example of an object. The data of a file may be an example of a data chunk in an object, and metadata of a file may be an example of S-meta of an object.

Moreover, a data VOL may be an example of a data area and an SSVOL may be an example of a snapshot that refers to partial unstructured data in the data area.

Moreover, in the extraction process, it may be determined whether the first S-meta 82S is suitable for a retrieval condition by referring to the first S-meta 82S instead of or in addition to extraction of data from the unstructured data source. When the determination result is true, the C-meta 83 may be created on the basis of the first S-meta 82S and the C-meta 83 may be associated with the first S-meta 82S suitable for the retrieval condition. In this case, one or more data chunks 81 referred to from the first S-meta 82S suitable for the retrieval condition may be an example of the unstructured data.

### REFERENCE SIGNS LIST

300 Storage apparatus

1. A data processing system comprising:
an interface unit which is one or more interfaces including an interface for accessing an unstructured data source including a plurality of pieces of unstructured data;
a storage unit including one or more memories; and
a processor unit which is one or more processors coupled to the interface unit and the storage unit, wherein
first-type metadata of at least one piece of unstructured data is associated with second-type metadata which is metadata including content information indicating one or more content attributes of the unstructured data,
for each of one or more pieces of unstructured data, two or more pieces of first-type metadata that refer to the unstructured data include:
a first piece of first-type metadata which is original metadata of the unstructured data; and
a second piece of first-type metadata which is metadata based on a copy of the first piece of first-type metadata associated with the second-type metadata suitable for a retrieval condition,
the processor unit is configured to display recommendation information which is information related to a plurality of virtual volumes recommended to be used in parallel,
the plurality of virtual volumes are associated with two or more second pieces of first-type metadata based on one or a plurality of overlapping degrees of a plurality of pieces of first-type metadata associated with a plurality of pieces of second-type metadata suitable for at least one of a plurality of retrieval conditions, and
each of the one or plurality of overlapping degrees is a value corresponding to a data amount of an overlapping portion of at least two reference destinations corresponding to at least two pieces of first-type metadata.

2. The data processing system according to claim 1, wherein
the two or more second pieces of first-type metadata associated with the plurality of virtual volumes are two or more second pieces of first-type metadata based on one or more overlapping degrees which are equal to or larger than a threshold.

3. The data processing system according to claim 2, wherein
when at least a data amount of an overlapping portion among the data amounts of reference destinations of the two or more second pieces of first-type metadata exceeds a capacity of a cache area in which data read and written with respect to the unstructured data source is temporarily stored, the plurality of virtual volumes are a plurality of virtual volumes associated with two or more second pieces of first-type metadata based on one or more overlapping degrees which are smaller than the threshold.

4. The data processing system according to claim 1, wherein
the plurality of virtual volumes are provided from at least one of a first storage apparatus that provides the unstructured data source and one or more second storage apparatuses coupled to the first storage apparatus.

5. The data processing system according to claim 4, wherein
a virtual volume provided from any of the one or more second storage apparatuses among the plurality of virtual volumes is a virtual volume associated with a second piece of first-type metadata which is copied from the first storage apparatus to the second storage apparatus.

6. The data processing system according to claim 5, wherein
the first storage apparatus has a cache area in which data read and written with respect to the unstructured data source is temporarily stored,
the processor unit is configured to determine whether at least a data amount of an overlapping portion among the data amounts of reference destinations corresponding to the two or more second pieces of first-type metadata based on the one or plurality of overlapping degrees, or at least a data amount of an overlapping portion among the data amounts of reference destinations corresponding to two or more first pieces of first-type metadata based on the one or plurality of overlapping degrees, is equal to or smaller than a capacity of the cache area, and
execute a metadata copying process corresponding to a result of the determination.

7. The data processing system according to claim 6, wherein
when the determination result is true, the metadata copying process is a process of copying only the corresponding first-type metadata and the second-type metadata associated thereto from the first storage apparatus to the one or more second storage apparatuses.

8. The data processing system according to claim 6, wherein
when the determination result is false, the metadata copying process is a process of copying the corresponding first-type metadata, the second-type metadata associated thereto, and unstructured data corresponding to these pieces of metadata from the first storage apparatus to the one or more second storage apparatuses.

9. The data processing system according to claim 5, wherein
the processor unit is configured to determine whether copied information including the second-type metadata is to be removed from the one or more second storage apparatuses on the basis of a time elapsed from a latest time point at which the second-type metadata copied in the one or more second storage apparatuses is suitable for any of the retrieval conditions.

10. The data processing system according to claim 5, wherein
the processor unit is configured to, when resources of the first storage apparatus are depleted while a plurality of processes using the plurality of virtual volumes are executed in parallel, copy the first-type metadata and the second-type metadata related to a virtual volume, used by unexecuted processes among the plurality of processes, to the one or more second storage apparatuses.

11. The data processing system according to claim 1, wherein
the processor unit is configured to:
search for one or more pieces of second-type metadata suitable for a retrieval condition designated from a user;
specify one or more first pieces of first-type metadata associated with the found one or more pieces of second-type metadata;
copy the specified one or more first pieces of first-type metadata; and
generate a virtual volume to be provided to the user, associated with one or more second pieces of first-type metadata obtained by the copying.

12. The data processing system according to claim 1, wherein
the recommendation information is information on one or more groups related to the plurality of virtual volumes among one or a plurality of groups, and
each of the one or plurality of groups is a group constructed by the processor unit and includes two or more pieces of first-type metadata having one or more overlapping degrees that satisfy a predetermined condition.

13. The data processing system according to claim 1, wherein
the processor unit is configured to narrow down at least one of (x) and (y) below on the basis of at least one of specification and performance of a storage apparatus that provides the unstructured data source:
(x) a group associated with the recommendation information; and
(y) first-type metadata included in at least one group among the one or plurality of groups.

14. A data processing method comprising:
receiving a request; and
displaying recommendation information which is information related to a plurality of virtual volumes recommended to be used in parallel in response to the request, wherein
first-type metadata of at least one piece of unstructured data among a plurality of pieces of unstructured data included in an unstructured data source is associated with second-type metadata which is metadata including content information indicating one or more content attributes of the unstructured data,
for each of one or more pieces of unstructured data, two or more pieces of first-type metadata that refer to the unstructured data include:
a first piece of first-type metadata which is original metadata of the unstructured data; and
a second piece of first-type metadata which is metadata based on a copy of the first piece of first-type metadata associated with the second-type metadata suitable for a retrieval condition,
the plurality of virtual volumes are associated with two or more second pieces of first-type metadata based on one or a plurality of overlapping degrees of a plurality of pieces of first-type metadata associated with a plurality of pieces of second-type metadata suitable for at least one of a plurality of retrieval conditions, and
each of the one or plurality of overlapping degrees is a value corresponding to a data amount of an overlapping portion of at least two reference destinations corresponding to at least two pieces of first-type metadata.

15. A computer-readable recording medium having recorded thereon a computer program for causing a computer to execute:
(a) receiving a request; and
(b) displaying recommendation information which is information related to a plurality of virtual volumes recommended to be used in parallel in response to the request, wherein
first-type metadata of at least one piece of unstructured data among a plurality of pieces of unstructured data included in an unstructured data source is associated with second-type metadata which is metadata including content information indicating one or more content attributes of the unstructured data,
for each of one or more pieces of unstructured data, two or more pieces of first-type metadata that refer to the unstructured data include:
a first piece of first-type metadata which is original metadata of the unstructured data; and
a second piece of first-type metadata which is metadata based on a copy of the first piece of first-type metadata associated with the second-type metadata suitable for a retrieval condition,
the plurality of virtual volumes are associated with two or more second pieces of first-type metadata based on one or a plurality of overlapping degrees of a plurality of pieces of first-type metadata associated with a plurality of pieces of second-type metadata suitable for at least one of a plurality of retrieval conditions, and
each of the one or plurality of overlapping degrees is a value corresponding to a data amount of an overlapping portion of at least two reference destinations corresponding to at least two pieces of first-type metadata.
